(19) United States
(12) Patent Application Publication
(10) Pub. No.: US 2015/0347751 A1
(43) Pub. Date: Dec. 3, 2015

(54) SYSTEM AND METHOD FOR MONITORING DATA IN A CLIENT ENVIRONMENT

(71) Applicant: SECCURIS INC., Winnipeg (CA)

(72) Inventors: Paul CARD, Winnipeg (CA); Aaron L MEIHM, Winnipeg (CA); David B. BERTOUILLE, Winnipeg (CA); Christian PERON, Winnipeg (CA); Michael LEGARY, Winnipeg (CA); Geoffrey BESKO, Howden (CA)

(21) Appl. No.: 14/654,488

(22) PCT Filed: Dec. 16, 2013
(86) PCT No.: PCT/CA2013/050971

§ 371 Date: Jun. 19, 2015

Related U.S. Application Data
(60) Provisional application No. 61/745,061, filed on Dec. 21, 2012.

(51) Int. Cl. G06F 21/55; H04L 12/741; H04L 29/08; H04L 29/06

(52) U.S. Cl. CPC G06F 21/554; H04L 63/20; H04L 45/74; H04L 67/10; G06F 2221/034

(57) ABSTRACT

Systems and methods are provided which enable client environments, such as corporate and government enterprises, to adopt an integrated, strategic approach to governance, risk and compliance. The systems described herein provide a “cloud-based” information security service that provides such enterprises with round-the-clock visibility into security issues and risks across the enterprise. An advanced security information and event management system, also referred to as an information assurance portal (IAP), is described, which enables client customers to select various services such as threat and vulnerability management, asset classification and tracking, and business threat and risk assessments through a software-as-a-service portal.

This application claims priority from U.S. Provisional Patent Application No. 61/745,061 filed on Dec. 21, 2012, the contents of which are incorporated herein by reference.

### TECHNICAL FIELD

The following relates to systems and methods for monitoring data in a client environment.

### DESCRIPTION OF THE RELATED ART

Organizations face increased pressure to manage operational costs while maintaining uninterrupted service. Rapidly changing and increasingly severe security threats can overwhelm information technology (IT) resources, posing increased risk to corporate reputations through the loss or theft of sensitive internal data and customer information.

For many organizations, unseen perils can also undermine strategic growth. For example, fraud-based financial threats, compliance violations, security breaches, malicious attacks, and data theft of ever-increasing complexity pose a daunting challenge for corporate enterprises. Therefore, a need exists for a comprehensive risk management solution which can leverage limited resources cost-effectively while balancing operational risk management, IT security, and threat response considerations.

### SUMMARY

In one aspect, there is provided a method of messaging comprising: receiving a first message from an external source, the first message comprising a header component included by the external source and a payload; generating a second message from the first message by modifying the first message to add at least one additional header component for routing the second message internally within a messaging framework; and routing the second message to at least one component in the messaging framework using the routing header.

In another aspect, there is provided a method of monitoring event data comprising: receiving event data from a data source; generating an event object from the event data; analyzing the event object using at least one correlator to determine a threat to an entity associated with the data source; generating a notification when the at least one correlator detects the threat; and sending the notification to a monitoring service to generate a ticket for resolving the threat.

In yet another aspect, there is provided a method of monitoring data in a client environment, the method comprising: obtaining data from the client environment indicative of activity within the client environment at a first component within the client environment; and the first component sending the data to a second component over a secure connection with the second component, the second component being located remote from the first component in a monitoring backend infrastructure.

In yet another aspect, the second component is located an intermediary separate from a central monitoring service, the above method further comprising the second component processing the data to generate a notification and sending the notification to a third component for initiating a remediation of a threat associated with the notification.

In yet another aspect, there is provided a computer readable storage medium comprising computer executable instructions for performing the methods above.

In yet another aspect, there is provided a system configured to perform the methods above.

### BRIEF DESCRIPTION OF THE DRAWINGS

Embodiments will now be described by way of example only with reference to the appended drawings wherein:

FIG. 1 is a schematic diagram of a client environment being monitored by an information assurance portal (IAP);

FIG. 2 is a schematic diagram of a client environment being monitored by an IAP utilizing an intermediary and assurance services;

FIG. 3 is a schematic diagram of a client environment being monitored by an IAP having multiple region hubs;

FIG. 4 is an example of a configuration for monitoring client data without an intermediary;

FIG. 5 is an example of a configuration for monitoring client data without an intermediary;

FIG. 6 is an example of a configuration for monitoring client data with an intermediary;

FIG. 7 is an example of a configuration for monitoring client data with an intermediary;

FIG. 8 is an example of a configuration for monitoring client data with an intermediary;

FIG. 9 is a schematic diagram of an example of a configuration for monitoring client data wherein a leaf node is deployed within a client environment;

FIG. 10 is a schematic diagram of an example of a configuration for monitoring client data wherein a leaf node is deployed within the IAP environment and a remote collector is deployed within the client environment;

FIG. 11 is a flow chart illustrating example computer executable instructions that may be performed in monitoring an event within a client environment;

FIG. 12 is a schematic diagram of an example configuration for an IAP;

FIG. 13 is a schematic diagram of an example configuration for an IAP providing a web service;

FIG. 14 is a schematic diagram of an example configuration for an IAP providing a web service and additional external services;

FIG. 15 is a schematic diagram of an example configuration for a leaf node;

FIG. 16 is a flow chart illustrating example computer executable instructions that may be performed in an example ticketing scenario;

FIG. 17 is a schematic diagram of a directory structure for identity management within an IAP;

FIG. 18 is a schematic diagram of a routable message structure in both front end and back end configurations;

FIG. 19 is a schematic diagram of a messaging topology;

FIG. 20 is a flow diagram illustrating an example message routing mechanism;

FIG. 21 is a schematic diagram illustrating an example transport encryption flow;

FIG. 22 is a schematic diagram illustrating a command module query;

FIG. 23 is a schematic diagram illustrating a socket pair between a leaf node and a command module;

FIG. 24 is a schematic diagram illustrating an example exchange of information in an identity signing process;

FIG. 25 is a flow diagram illustrating a topology ingress check;

FIG. 26 is a schematic diagram illustrating an example configuration for integrating a session handler with a hub and web service;

FIG. 27 is a flow diagram illustrating an example initialization of a hub session by a web service;

FIG. 28 is a vulnerability count chart for an example client environment;

FIG. 29 is a cumulative impact chart for an example client environment; and

FIG. 30 is a vulnerability count chart organized by asset subgroup for an example client environment.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will also be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

Systems and methods are provided which enable client environments, such as corporate and government enterprises, to adopt an integrated, strategic approach to governance, risk and compliance.

The systems described herein provide a “cloud-based” information security service that provides such enterprises with round-the-clock visibility into security issues and risks across the enterprise. An advanced security information and event management system, also referred to as an information assurance portal (IAP), is described herein, which enables client customers to select various services such as threat and vulnerability management, asset classification and tracking, and business threat and risk assessments through a software-as-a-service portal. It can be appreciate that an assessment performed by the IAP can occur against any type of asset in the customer's system, i.e. more than just technical assets. For example, the customer can define a policy as an asset in their asset system. From here the customer may choose to assess this asset which will result in a contextual action. In the case of a policy, it may prompt the user to upload the policy where it will be reviewed by an analyst in the backend. With a server, it could launch an automated vulnerability scan. The services enabled by the IAP described herein include, without limitation:

Threat Management-24×7 monitoring and correlation of activity and traffic on all connected security devices deployed throughout an organization to identify and escalate potential threats and malicious activity. Such threat management enables corrective action to be taken and support to be provided by expert security analysts.

Vulnerability Management—On-demand scanning and assessment of the technical and environmental vulnerabilities in an organization's computing infrastructure to identify, quantify, and prioritize the information security strengths and weaknesses of the computing environment, and provide a plan-of-action to mitigate the risk of serious consequences.

Client Asset Classification and Tracking—Tightly couples organizational information assets and threat and vulnerability data to effectively measure and present a complete picture of business risk.

Business Threat and Risk Assessment—In-depth analyses and interpretations of the risk present in an organization's business and technical environment. This risk assessment enables an organization to identify weaknesses that may contribute to failure of confidentiality, integrity, availability, or accountability; and recommend actions to mitigate risk to an acceptable level.

The information provided by the IAP can be configured to focus on incidents impacting business operations, thus supporting effective risk based decision making at all levels of the organization, based on accurate real-time information about the organization's current security posture and exposure to the external environment. For executives this means a top-down view of the organization's information security risk exposure and how it affects their business objectives and critical information assets. For information security managers it provides an operational view of the status of security incidents; the organization's current security posture; and enables more effective decisions for planning security operations and executing day-to-day activities. For information security analysts and IT practitioners it provides an advanced toolset (including state-of-the-art correlation algorithms, security information event management, and workflow applications) for identifying and correlating threat events, prioritizing and responding to incidents, managing vulnerabilities, and supporting daily security operations

The IAP described herein provides several strategic advantages. The IAP can be used to improve threat protection by enabling 24×7 visibility and facilitating effective incident response to external and internal threats and unauthorized intrusions. The IAP may also facilitate compliance by providing enhanced information security controls, online real-time information, and comprehensive reporting to ensure compliance with various industry regulations. The IAP can also enable improved operational efficiency by providing more effective management and monitoring of a security environment with real-time views of the efficiencies/inefficiencies of information security systems, allowing key stakeholders to identify where and how performance can be improved. Various other advantages include, without limitation, proactive management to improve processes for identifying and remediating technical vulnerabilities before they impact your business, cost savings to reduces costs (e.g. for staffing, training, maintenance, and infrastructure) associated with securing information assets, and enhanced security posture, which ensures proactive risk management and improves an organization's overall security posture by gaining a deeper knowledge of potential problems and allowing senior leadership to make decisions faster and more effectively.

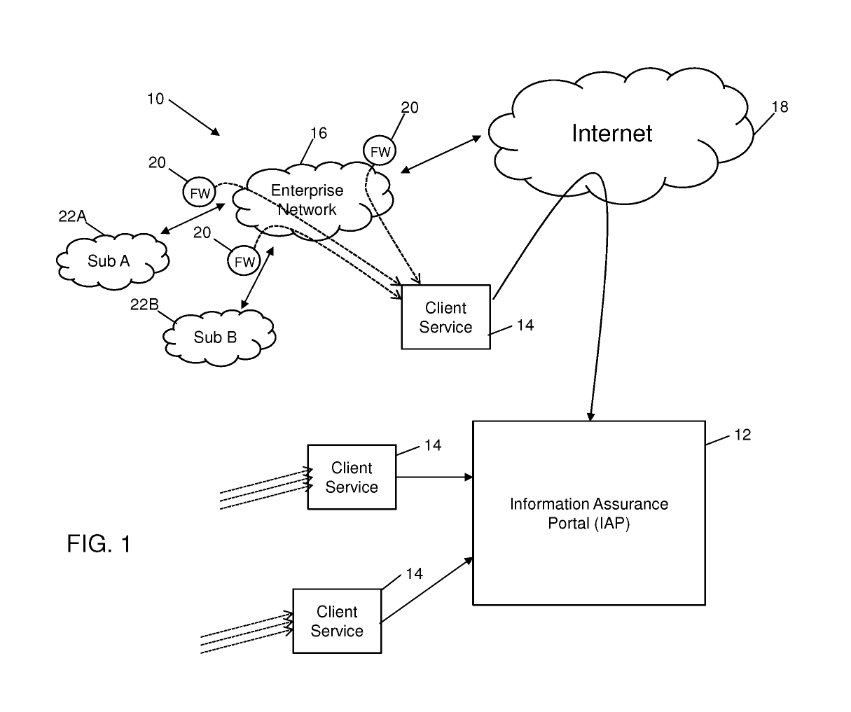

Turning now to FIG. 1, an example of a client environment 10 is shown. The client environment 10 in this example includes an enterprise network 16, which may be operated for and by any organization, e.g., corporate businesses, governments, etc. The enterprise network 16 includes at least one access point to a public network, in this example a public internet 18. The enterprise network 16 includes, in this example, a firewall (FW) 20 for providing a level of security to data received by and sent from the enterprise network 16. It can be appreciated that although not shown in FIG. 1, the enterprise network 16 may include various user equipment devices such as fixed computing terminals, mobile devices, as well as networking and communication infrastructure suitable to the requirements of the associated organization. The example client environment 10 shown in FIG. 1 also includes a pair of sub-networks 22A and 22B, which are connected to and associated with the enterprise network 16. It can be appreciated that the presence of sub-networks 22 within the client environment is purely illustrative. The sub-networks 22A and 22B may communicate with the enterprise network 16 through respective firewalls 20.

An information assurance portal (IAP) 12 is also shown in FIG. 1, which is communicably connectable to the enterprise network 16 and its data, via a client service 14 and the internet 18 in this example. As shown in FIG. 1, the IAP 12 is capable of communicating with multiple client services 14 and respective other client environments 10 (not shown). The IAP 12 is a system that provides a platform and framework for monitoring client data, such as internet traffic, login requests, etc.; and detects events that can be used for later analysis or to generate notifications that may be escalated and tracked by security analysts. The IAP 12 not only provides a client portal for visibility, but also utilizes a messaging framework to securely manage data for multiple clients without being vulnerable to outside threats or cross-compromises. Additionally, the IAP 12 includes or communicates with client service components (discussed in greater detail below) that leverage predefined correlators to enhance threat detection. The IAP 12 is configured to provide at least the following functionality:

Threat management (MTM): The identification and management of threats which are materializing with the client environment 10.

Vulnerability management (VM): The identification and management of vulnerabilities within the client environment 10.

Operational risk modeling (ORM): Based on inputs from the threat and vulnerability management, the identification of risk scenarios beyond the risk appetite of the client environment 10.

Business risk modeling (BRM): Based on the performance of the other services, an overall business risk model which can be used to communicate enterprise risk, and provide information to assist with security roadmap and budgeting decisions.

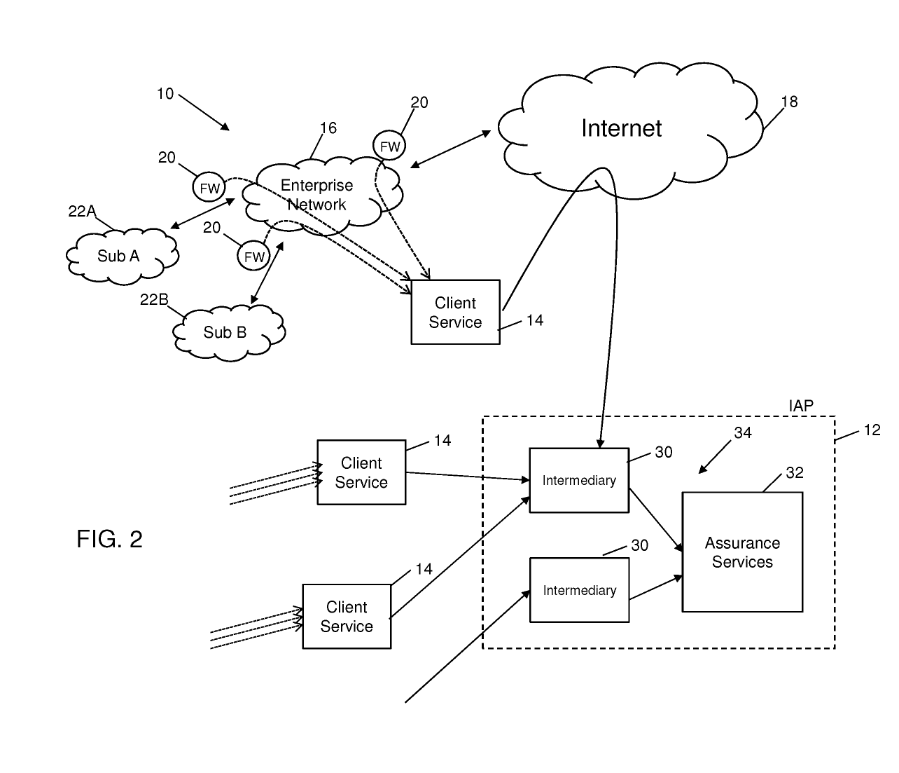

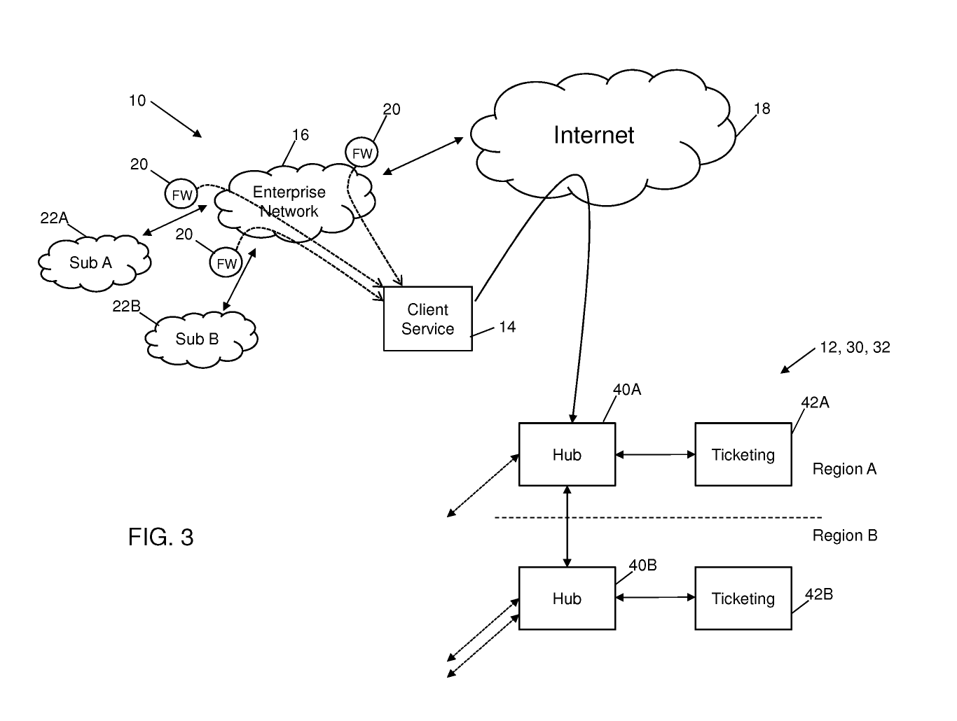

The IAP 12 may be configured in various ways, as illustrated in FIGS. 2 and 3. In FIG. 2, it can be seen that at least a portion of the functionality of the IAP 12 can be provided by intermediaries 30. For discussion purposes, the following may refer to the IAP's “core services” using reference numeral 34 regardless of how many entities collectively provide such services. It can also be appreciated that the client service 14 may also include components of the IAP 12, e.g., where the client environment 10 includes collection and correlation functionality as explained in greater detail below. In the example shown in FIG. 2, the core services 34 are provided by multiple intermediaries 30 and central assurance services 32. The intermediaries 30 may be provided by the same organization entity as the IAP 12 or may be separate organizational entities operating as “re-sellers” of the assurance services 32 by obtaining client data on behalf of the IAP 12. For example a telecommunications operator may act as the intermediary 30 providing at least some of the services provided by the IAP 12 while communicating with the assurance services 32 to conduct threat monitoring and security analyses.

One example of components that may execute the functionality of the IAP 12 is shown in FIG. 3. In FIG. 3, the client service 14 communicates over the internet 18 with a first hub 40A in Region A. A second hub 40B in Region B is also shown in FIG. 3 to illustrate that multiple hubs 40 can be distributed in order to service respective regions while sharing information between the hubs 40 to exchange knowledge of connected peers. For example, hub 40A and hub 40B may empirically develop new correlators for determining threats and share these new correlators to benefit other clients in the system. The hub 40 is an IAP component that coordinates messaging between the client environment 10 and the IAP 12 and enables authentication and ticketing services to be conducted internally within the IAP 12. In this example, each hub 40A, 40B is communicably connected to a respective ticketing component 42A, 42B for initiating ticketing of events detected by the system. It can be appreciated that the hubs 40 may also utilize the same ticketing component 42 and separate ticketing components 42A, 42B are shown for illustrative purposes only.

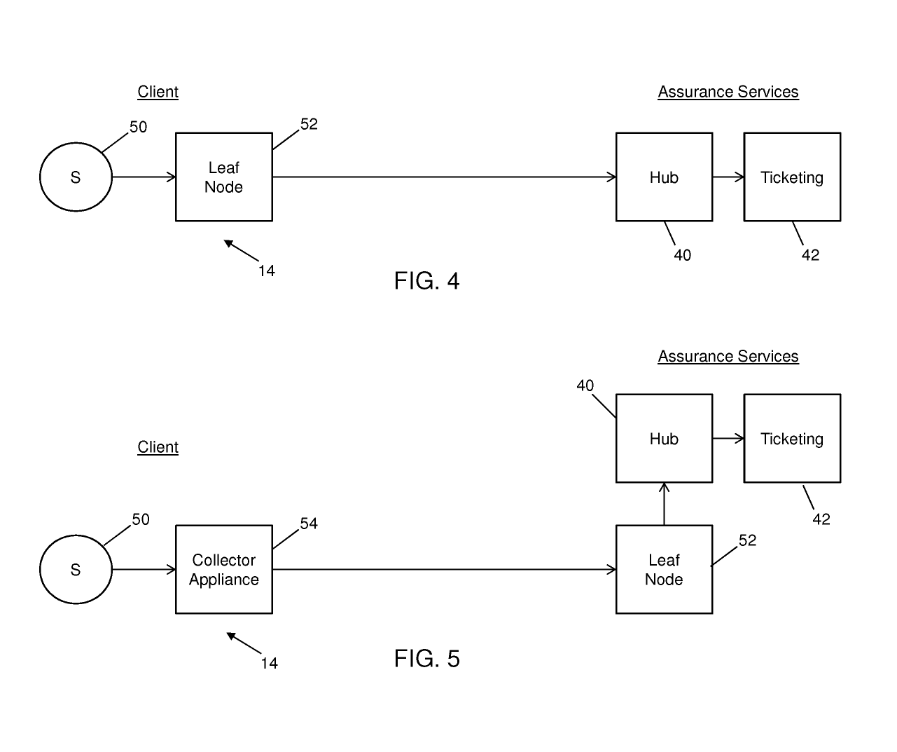

FIGS. 4 through 8 illustrate various example configurations for the IAP 12 and client services 14. In FIG. 4, a client data source or service 50 provides data to an on-site leaf node 52. The leaf node 52 is a client-specific service and/or collection of IAP components that obtain and analyze client data by applying predetermined and dynamically modifiable correlators to event objects associated with the client data in order to identify notable traffic in the client environment 10. For example, data being sent to a “blacklisted” IP address in the internet 18 may be detected triggering a threat notification. The leaf node correlators may be configured as a library of pluggable modules with each module having a set of instructions to apply to an event stream to detect such notable traffic. These modules may be directed towards internal and external network based security issues, operating system and application based security issues, data loss and PCI related issues, and other module sets related to enterprise security. The leaf node 52, when located within the client environment 10 sends event objects in a secure manner over the internet 18 or other available communication connection to the hub 40. The hub 40 performs authentication and reporting services and communicates with a ticketing component 42 to identify, track, and resolve security threats, initiate remediation of a security breach, communicate with IT agents within the client environment 10, etc. The ticketing component 42 enables security analysts to be engaged in the monitoring and remediation and may also include automated processes, e.g., for communicating with the client environment 10 to identify threats, escalate threats, etc.

FIG. 5 illustrates a configuration wherein the client data source 50 feeds into a collector appliance 54 within the client environment 10. The collector appliance 54 provides a secure way to collect client data on site and transport this data to a leaf node 52 that is not located on site. In FIG. 5, the leaf node 52 is part of the IAP's assurance services 52 along with the hub 40 and the ticketing component 42. The collector appliance 54 may be configured as a custom operating system image (e.g., FreeBSD®) containing IAP software components that can be provided to the customer in the form of an install image. The customer is then able to use the image to install the appliance on available physical or virtual hardware in their client environment 10.

An example architecture for the collector appliance 54 will now be described. The collection appliance architecture in this example resides in the client environment 10 and accepts log data from data sources 50 in that environment 10. The collector appliance 54 may be configured to support, for example, reception of SYSLOG data over UDP and TCP, SYSLOG data over TCP/SSL on port 814, and also SNMP traps. A collector gateway (not shown) may be provided at an intermediary 30 and shared amongst a number of collector appliance users. The collector gateway is used to collect data coming in from various collector appliances 54, decompressing and validating the integrity of the data, and sending the data to the client's leaf node 52. The collector appliances 54 deployed in client environments 10 may connect to the collector gateway over, for example, TCP port 450. The protocol used may be a custom protocol developed for the collector architecture. To install the collector appliance 54 in the example described herein, the customer boots a supplied OS image and follows various installation instructions. In order for the collector appliance 54 to establish a connection with the gateway, the appliance 54 is given connectivity to TCP port 450 on the collector gateway, wherein the IAP 12 has configured the collector gateway to permit a connection with the collector appliance 54. This involves assignment of a “source name”, and a “source key” to the collector appliance 54.

The customer supplies the same source name and source key during installation of the collector appliance 54, which is akin to providing a username and password that the collector software uses to “log in” to the gateway. From the console, the collector appliance 54 provides several commands that can be used, including without limitation:

Reconfigure: launch the configuration menu interface, allowing the customer to reconfigure the appliance 54 without reinstalling it (e.g., change IP address).

Lwcflush: This command deletes all dynamic data on the appliance 54, and resets it to appear as it would have after installation. This can be used to troubleshoot problems if the collector is not functioning correctly.

Halt: Shutdown the appliance 54.

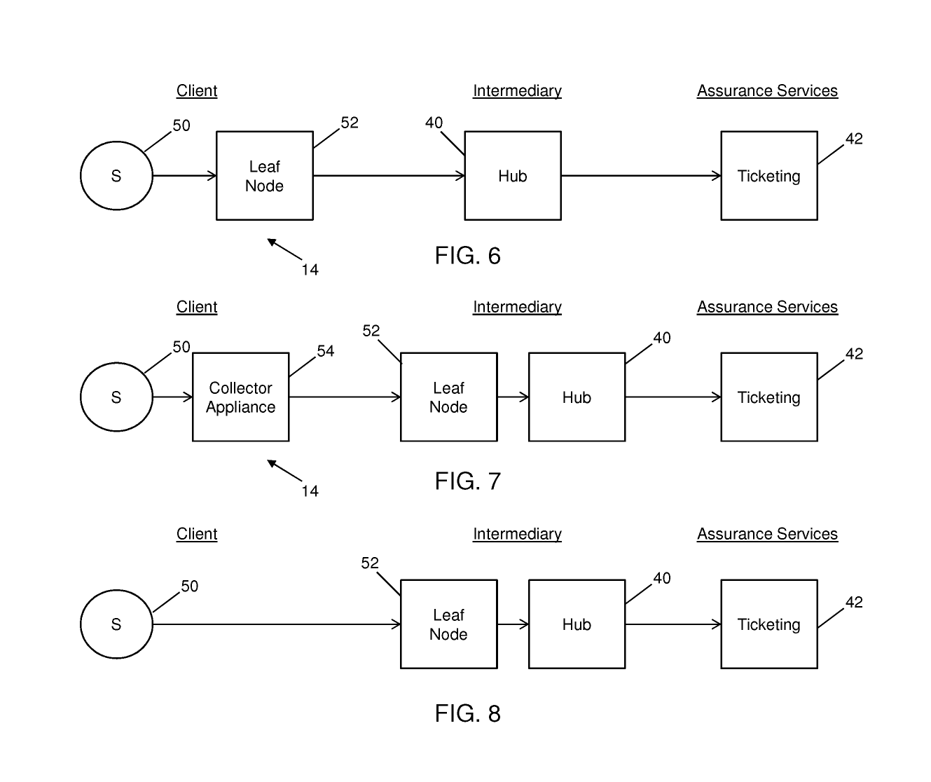

Referring now to FIGS. 6 to 8, various configurations are shown that utilize an intermediary 30 to provide at least a portion of the IAP's functionality. In FIG. 6, it can be seen that the client environment 10 includes a leaf node 52 communicating with a hub 40 located at the intermediary 30. The hub 40 is also communicably connectable to the ticketing component 42 which is located within the assurance services 32. In FIG. 7, a collector appliance 54 is located in the client environment 10 and the leaf node 52 and hub 40 are located at the intermediary 30. In FIG. 8, the client data source 50 feeds directly to the leaf node 52 located at the intermediary 30. It may be noted that the configuration in FIG. 8 may be less secure but can accommodate client environments 10 where the customer does not want to incur the time or expense to install a collector appliance 54 or leaf node 52 but is capable of feeding data to the intermediary 30.

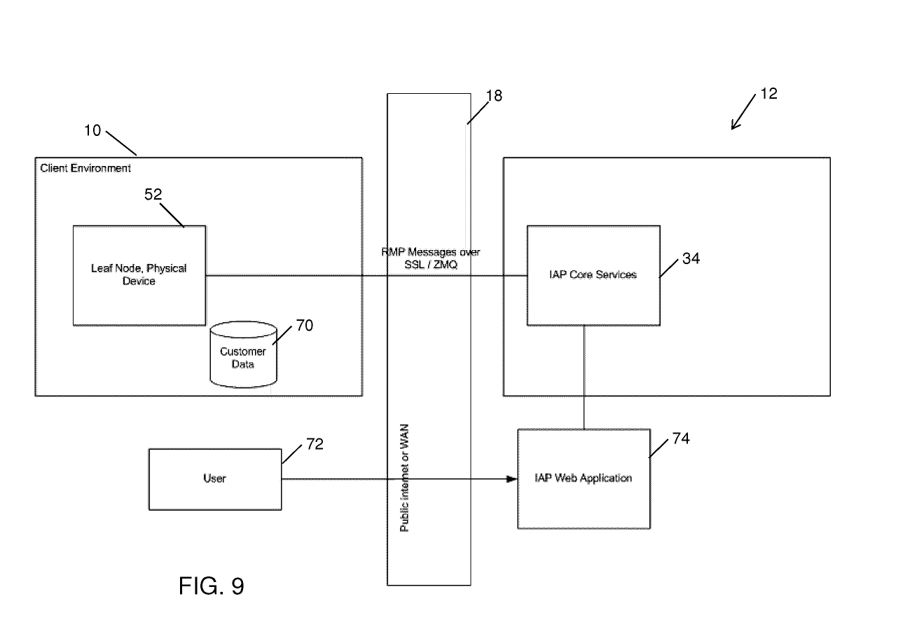

FIG. 9 illustrates further detail of an example of the configurations shown in FIGS. 4 and 6. In the configuration shown in FIG. 9, the client environment 10 includes both the leaf node 52 on site as well as customer data 70 stored on site and made accessible to the leaf node 52 for applying correlators against the customer data 70. Messages may be sent to the IAP core services 54 within the IAP 12 over the internet 18, e.g., using a secure sockets layer (SSL) protocol. As will be discussed in greater detail below, the messages utilize a custom messaging protocol, hereinafter referred to as the routable messaging protocol (RMP) in order to enable components within the IAP 12 to communicate with each other. A stripped down version of RMP may also be used outside of the IAP environment, e.g., in a web-based front end, to allow, for example, a user 72 to communicate with the IAP 12 without having access to potentially sensitive routing and identity information that is included in the message structure utilized internally by the IAP 12. The user 72 may communicate with the IAP 12 over a public connection on the internet 18 via a web application 74. Users may include, for example, customer technical staff interested in viewing threats and notifications and otherwise communicating with the IAP 12.

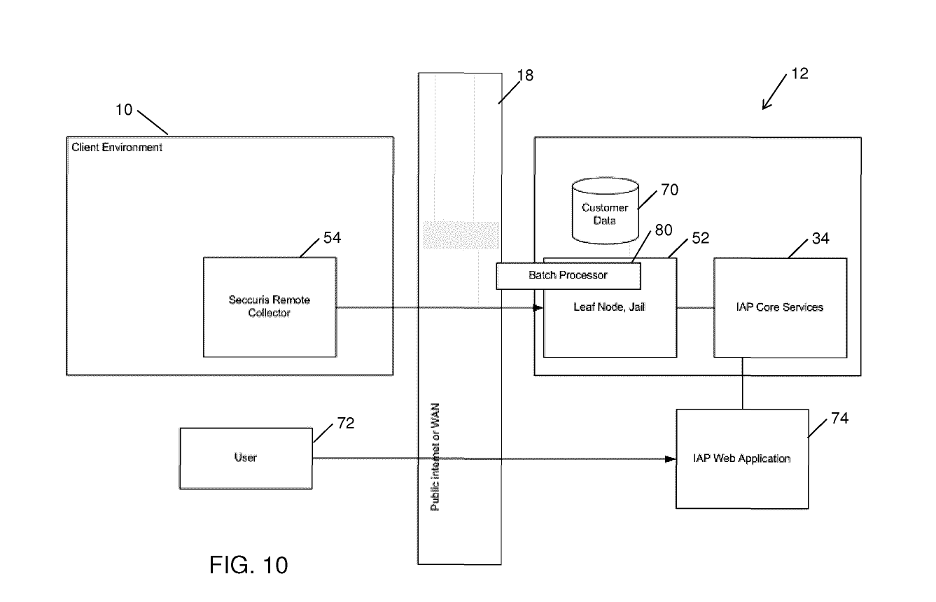

FIG. 10 illustrates further detail of an example of the configurations shown in FIGS. 5 and 7. In the example shown in FIG. 10, a collector appliance 54 is located within the client environment 10 whereas the leaf node 52 is located within the IAP 12 environment. The collector appliance 54 may communicate with the leaf node 52 using a secure protocol such as an SSL tunnel. The customer data 70 in this example is stored within the IAP 12 environment and a batch processor 80 may be executed by the leaf node 52 to process a “batch” of data when, for the collector appliance 54, the log data comes in via periodic batches, rather than a continuous event stream as would occur with a leaf node 52 on-site.

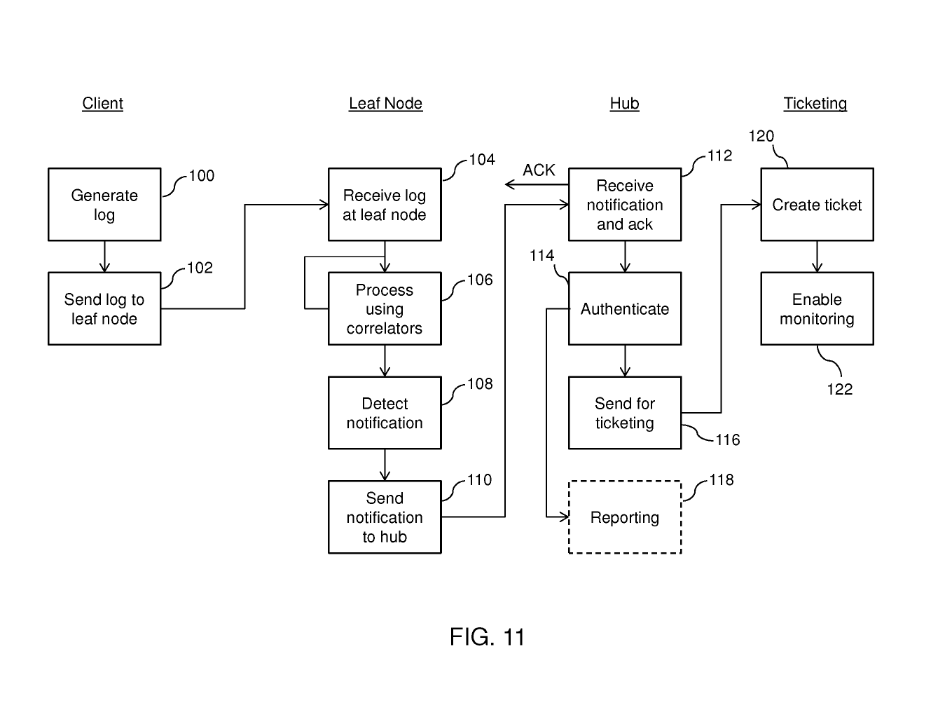

FIG. 11 illustrates an example of a set of computer executable instructions that may be executed in monitoring client data using any one of the configurations shown in FIGS. 4 through 8. At 100 a log is generated in the client environment 10, e.g., a transaction is recorded by a firewall 20 in the enterprise network 16. The log is sent to the client's leaf node 52 at 102. The leaf node 52 receives the log (perhaps along with additional log records and/or other data) at 104 and processes the client data associated with the log at 106 using correlators and other components, further detail of which is exemplified below. At 108 the leaf node 52 detects a notification of a threat, generated in the processing performed at 106, and sends the notification to the hub 40 at 110. The hub 40 receives the notification at 112 and acknowledges receipt of the notification. The hub 40 may then authenticate the message at 114 and send the notification for ticketing at 116. The ticketing component 42 creates a ticket associated with the notification at 120 and enables the potential threat to be monitored at 122, e.g., by enabling a security analyst to access and view the ticket and/or be assigned to a ticket. The hub 40 may also enable reporting at 118, the reporting including details of the notification received at 112.

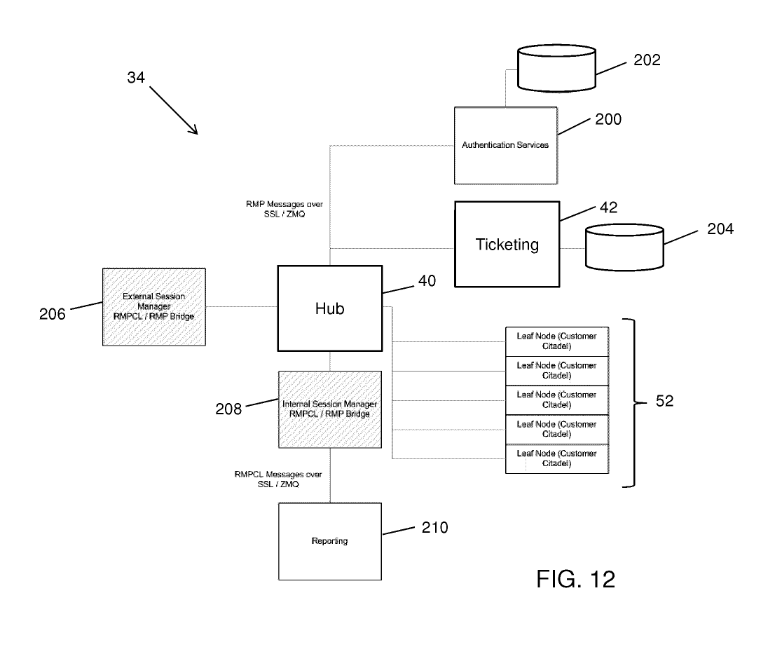

Example configurations for the assurance services 34, illustrating operation of the core IAP services 34, are shown in FIGS. 12 to 14. As seen in FIG. 12, an external session manager 206 is provided, which provides a bridge between externally connected clients (and other external components), and the hub 40. The hub 40 is connected to an authentication service 200 for authenticating those accessing the IAP 12. The authentication services 200 include or otherwise have access to a database 202 for storing data utilized by the authentication services 200. The hub 40 is also communicably connected to the ticketing component 42 for ticket integration, e.g., to initiate monitoring of a detected threat. The ticketing component 42 includes or otherwise has access to a database 204 for abstracting a third party ticketing application to make access from the IAP 12 uniform, regardless of what is being used. The ticketing application stores the actual data in the database 204, and the ticket component 42 accesses this data from the application and presents it in a standardized way to the IAP 12.

As will be explained in greater detail below, the hub 40 is a central component of the messaging framework used by the IAP 12 and communicates with internal reporting 210 via an internal session manager 208 and the leaf nodes 52 connected into the IAP 12. The messaging architecture ensures that any compromise of one leaf node 52 will not compromise other leaf nodes 52 connected into the system, and through the external session manager 206, the internal routing mechanisms used by the IAP 12 are obfuscated from the front end systems, e.g., web-based interfaces.

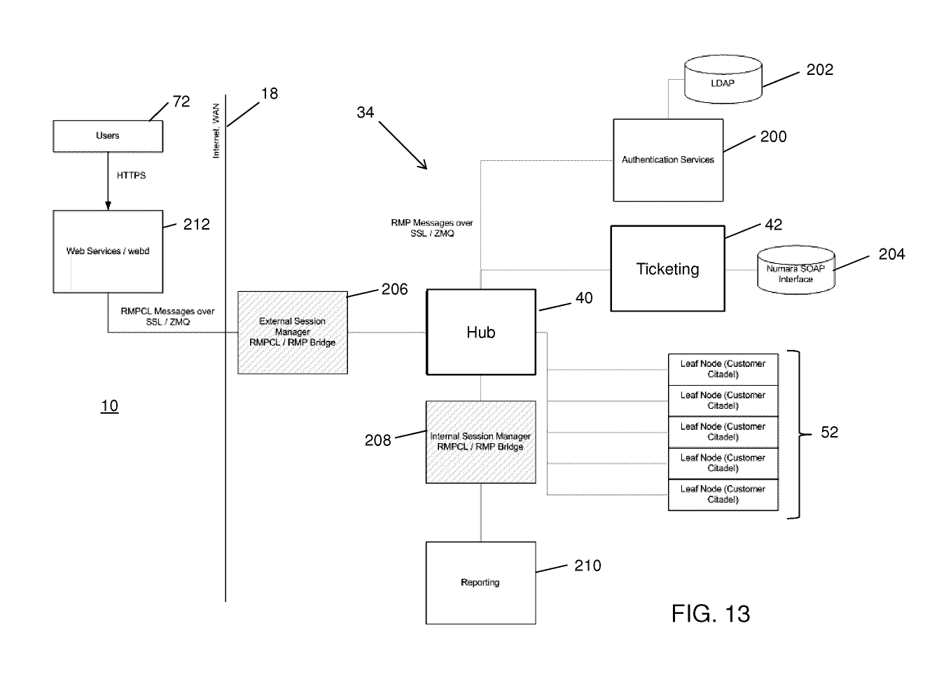

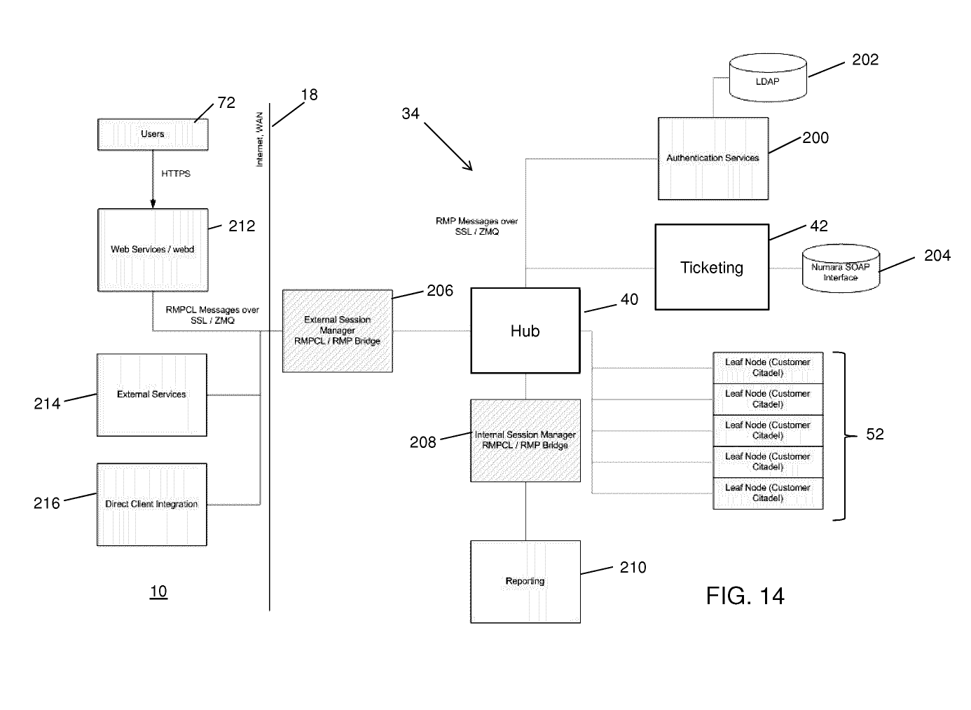

FIG. 13 illustrates a configuration in which users 72 can connect to the IAP 12 over the internet 18 via web services 212. The web services 212 integrate a web portal that allows users 72 to communicate with the IAP 12 using a stripped down version of the messaging structure used internally by the IAP 12, details of which are provided below. In this way, the web services 212 are not exposed to the internal routing, addressing and component IDs used by the system, to inhibit the backend systems within the IAP core services 34 from being compromised by external web-based entities. The web services 212 also provide a user interface for clients as well as users and administrators of the IAP 12. The web services 212 communicate with the hub 40 via the external session manager 206 within the IAP core services 34. As shown in FIG. 14, the external session manager 206 may also be configured to communicate with other external services 214 and direct client integration solutions 216.

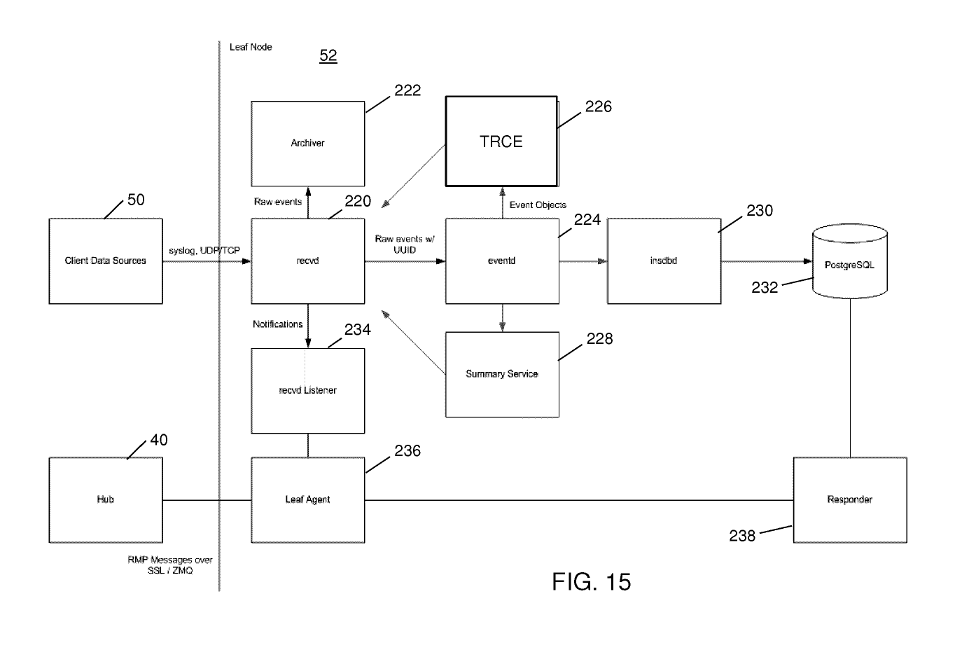

Further detail of an example of a configuration for the leaf node 52 is shown in FIG. 15. As discussed above, the leaf node 52 receives data reports or logs from client data sources 50, e.g., log data reported by a firewall 20. The client data sources 50 communicate with a read/write engine, labeled “recvd” 220 in FIG. 15. Recvd 220 reads line buffered data from various types of sockets, and writes this data to other sockets in a high speed, trusted, and reliable manner. Recvd 220 upon receiving data from the client data source 50 writes this data to an archiver 222, and an event converter named eventd 224. The archiver 222 reads the event data from a socket and writes the event data to memory in its native format, along with a cryptographic hash that can be used to validate the integrity of the data at a later time. The eventd 224 processes the incoming event data from a domain socket and converts this data into a stream of event objects for consumption by other components, in this example, a correlator engine named TRCE 226, a database interface named instdbd 230, and a summary service 228.

The instdbd 230 reads the event objects from a domain socket and periodically batch inserts the objects into a database 232, in this example, an SQL database 232, for subsequent queries by a leaf agent 236 via a responder 238. The summary service 228 reads event objects from a socket and applies real-time trending to the event objects to produce summaries that can be viewed by a user via the reporting engine 210 or via other view, e.g. a portal dashboard or other web interface.

The event objects are output by the eventd 224. Event objects are structured as a hierarchal object system, based on an “event” superclass. Log data is converted into an event object, which is then passed around the leaf node architecture in a binary format, which advantageously removes requirements to continuously reparse log lines. At this stage, event objects will be “enriched” with additional information that can be used by TRCE 226 later. This can include for example asset information, geo-IP location information, or identity information (the name of the user using the technology asset that generated the event).

The TRCE 226 may be a server based application in which a configurable group of predefined correlation rules (correlators) can be applied to a stream of incoming event objects with an aim to identify notable traffic, for example, security incidents that should be investigated further. The TRCE 226 feeds back the finding from application of the correlators to the recvd 220 in order to enable the recvd 220 to generate notifications that are detected by a recvd listener 234 that communicates with the leaf agent 236 to pass notifications to the hub 40 and responder 238. As discussed above, the correlators may be stored as a library of pluggable modules, wherein a module is a set of instructions to apply to an event stream to detect such notable traffic. The modules may be directed to internal issues, external network based security issues, operating system and application based security issues, data loss and PCI related issues, among other issues related to enterprise security.

The TRCE 226 provides interfaces to normalize and correlate events in order to create alerts fed back to the recvd 220 to enable notifications to be generated. Parser plugins are responsible for normalizing event strings into object, and input filter plugins control which events reach to the correlators. Correlator plugins can look for particular events or sequences of events and create alerts. Output filter plugins can be used to filter out alerts created by the correlators, and the alerts can be sent to the local systems syslog. TRCE 226 may operate primarily through the use of plugins. If the input mode is raw, parsers are responsible for transforming lines into normalized objects. Whenever an event is received, it is fed through each loaded input filter plug-in. If the event matches any of the filters, it is discarded. If an event passes all input filters it moves into the correlation phase. The first thing the correlator plugins do is to create a key from an event. Keys determine which events should be grouped together. New instances of each correlator are created for each unique key. Any set of events with the same key will be sent to the same correlation instance. Each correlation instance has a timeout associated with it. When that timeout is reached, the instance may be discarded, losing any state that it has kept. Alerts may be created on any received event or on the reception of a timeout signal. In addition to alerts, correlators can create one-time filters (OTFs). OTFs are used to filter alerts that have already been created and published. Alerts created by correlators are sent to each output filter plugin before being published. If one filter matches the alert, then the alert will not be published. Each plugin has the ability to define it's own configuration, however, in practice may follow the same key/value format.

The following provides an example use of keys, including key1=val1, and key2=val2.

If a correlator uses a default configuration, the configuration file can be replaced with an INI formatted file to allow for overriding configurations for instances with a particular key. A default section may be used for keys where an override does not exist. Sections in which names match the key strings will use the configuration in that section. In this example every instance that isn't keyed by 192.168.0.1 uses the values key1=val1 and key2=val2. The instance keyed by 192.168.0.1 will use key1=val3 and fall back to the default key2=val2 since it does not define it. Example:

[default]

key1=val1

key2=val2

[192.168.0.1]

key1=val3

The use of event objects also facilitates a convenient query language for querying the IAP 12. The query language implementation enables querying threat monitoring data, but is extensible to enable querying of any data in the system. In one example, the general format the language takes appears as “functions”, where the function has parameters to filter information. For example, to query all threat data in the system the function: “threat( )” can be used, which will match all event data classified as threat data. Additional functions exist, for example to only query network flow data “flow( )” can be used, or for only IDS events “idp( )” can be used, and correlated events can be queried using “cor( )”.

The parameters can be specified in the language to filter further, for example to query only correlated events that involve source ip 1.2.3.4, the following query can be used: “cor(srca=“1.2.3.4”)”. Instead, additional destinations of 2.3.4.5 and source of 1.2.3.4 can be queried by using the following: “cor(srca=“1.2.3.4”, dsta=“2.3.4.5”)”.

The pipe (|) can be used as an OR to allow multiple queries, for example, show correlated events from 1.2.3.4 and all flow events: “cor(srca=“1.2.3.4”)|flow( )”. The intent is for the query language to be expanded to include vulnerability and asset information to produce risk scores. For example, the following can be used to query for vulnerabilities related to CVE-2012-001: “vuln(cve=“2012-001”)”. This can be expanded further to include the threat query, so the following would show any threat events that were detected that were directed against an existing vulnerability related to 2012-001: “threat(vuln(cve=“2012-001”))”. This differs from the query “threat(cve=“2012-001”)”. The first variant will list known threat events that occurred directed towards an asset that has a known vulnerability related to CVE 2012-001, and the second list all threats that had the potential to exploit 2012-001, regardless of known vulnerabilities in the environment 10.

A risk function can also be added, which performs risk calculations based on the data sets returned by the functions. For example, to calculate risk associated with all vulnerabilities and threats detected in the environment 10, the following query can be made: “risk(threat( ) vuln( )”. To calculate risk associated with a specific asset, the following query can be made: “risk(threat( ), vuln(asset=“database-server”))”, and to calculate risk but only use correlated threat data, the following query may be used: “risk(cor( ) vuln( ))”. Through the query language, very complex queries can be executed by the user to understand risk to information assets using a variety of abstracted data sources, and help analyze data to understand impact.

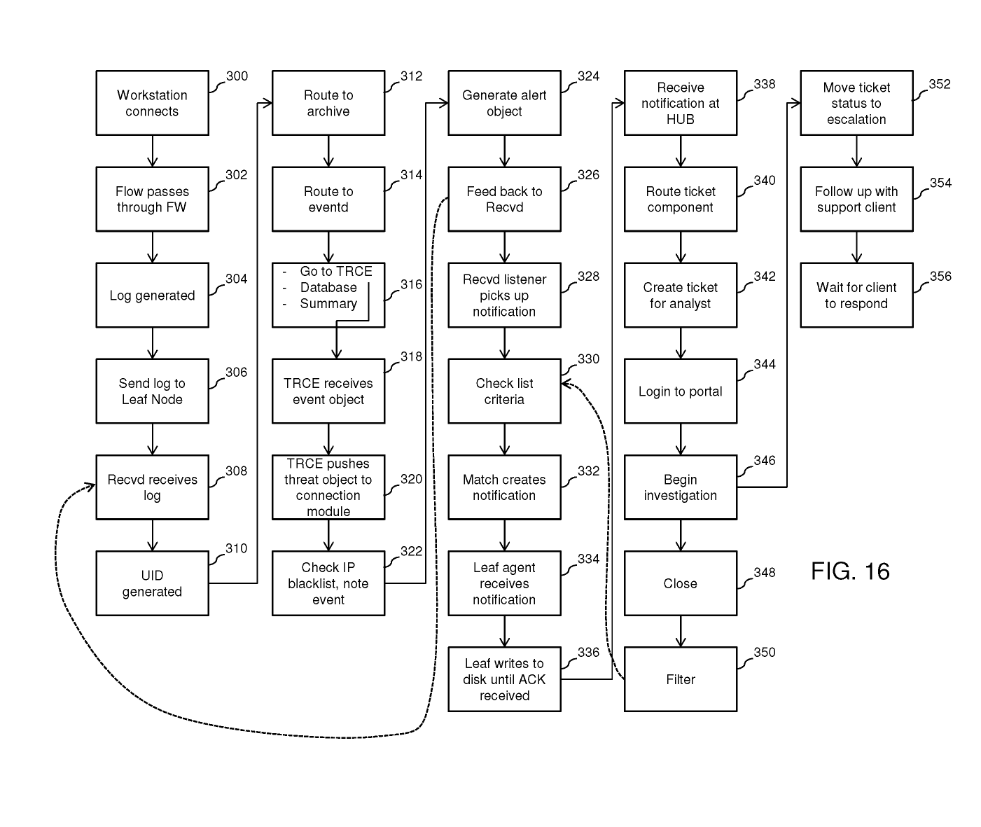

FIG. 16 illustrates an example ticketing scenario. In this example, it is assumed that a workstation within a client environment 10 connects to the enterprise network 16 at 300 and due to an interaction with the enterprise network 16 (e.g., connection to the internet 18 or sending of an email), data flow passes through the firewall 20 at 302. This data flow causes a firewall log to be generated at 304 and the log is sent by the client data source 50 to the leaf node 52 for the client environment 10 at 306. The leaf node 52 receives the log using the recvd 220 at 308. The recvd 220 generates a unique ID (UID), assigned to each event, at 310 in order to track the event in the system. Every event has a UID, even across clients. The recvd 220 also routes the event data to the archiver 222 at 312, and routes the data to the eventd 224 at 314. The eventd 224 converts the event data into one or more event objects which are passed to TRCE 226, the database 232 via insdbd 230, and the summary service 228 at 316. The subsequent operations focus on operations performed after the event object is processed by TRCE 226. At 318 TRCE 226 receives the event object and pushes the object to the connection module at 320 to perform a correlation. In this example, the correlator used checks an IP address blacklist at 322 and it is assumed that a threat event is noted based on this check. An alert object is then generated by TRCE 226 at 324 and fed back to recvd 220 at 326. Recvd generates a notification which is picked up by the recevd listener 234 at 328. The recvd listener 234 checks a list of criteria for determining if the notification should be passed to the IAP core services 34 via the hub 40 at 330.

In this example it is assumed that at least one criterion is met matching the notification to the list at 332 and the leaf agent 236 receives the matched notification at 334. The leaf agent 236 writes the notification to disk at 336 and sends the notification to the hub 40. The notification is kept until an acknowledgement is received from the hub 40. The hub 40 receives the notification at 338 and routes the notification to the ticketing component 42 at 340. A ticket is created for an analyst at 342. The analyst may then login to a portal at 344 to begin an investigation at 346 until the investigation closes at 348. A filter may be performed at 350. Filters may be used to filter data entering the TRCE 226. A filter can be applied to specific log data, e.g., so that the log does not trigger future alerts if it is determined to be a false positive.

When an investigation is begun at 346, the ticket is reviewed and the threat monitored. In this example it is assumed that the ticket status is moved to an escalation at 352 to highlight the potential vulnerability. For example, the analyst may review alerts, and if they are determined to be valid they are escalated to the client (client is notified of an incident taking place on their network). At this point, the analyst may follow up with the support client at 354, or an email or other communication may be sent automatically. The analyst and/or system may then wait for client feedback or a response confirming that the threat has been addresses, the system shut down, or other remediation is in progress.

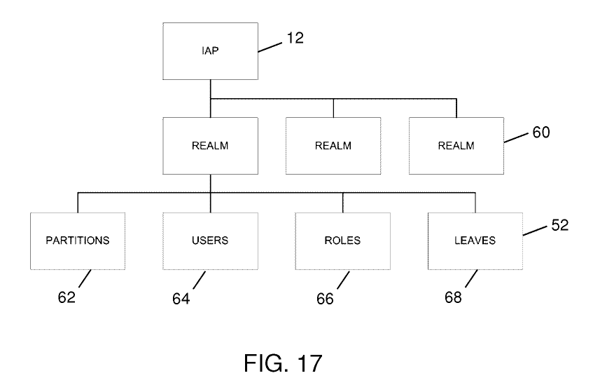

FIG. 17 illustrates a high-level directory structure that may be used to manage user identities and associated privileges within the IAP 12. An IAP realm 60 represents a collection of users 64, leaf nodes 68, and customized roles 66. Typically a realm 60 will correspond to a particular client within the system. A user 64 within a particular realm 60 may access information on leaf nodes 68 within that realm 68 only, assuming the user 64 has been granted the necessary privileges. A leaf object represents a leaf node 68. A directory service may be used to maintain a list of leaf nodes 68 within a realm 60, and leaf nodes 68 can be assigned to partitions 62 within the realm 60. It can be appreciated that a leaf node 68 may be a member of multiple partitions 62. A role 66 is a collection of privileges and a user 64 may customize roles 66 within a particular realm 60 if they have the appropriate entitlements (e.g., realm role management privileges, etc.). Roles 66 are assigned to users within a realm 60, and a user 64 may have multiple associated roles 66. A user 64 represents an individual who has access to the IAP 12. The user object contains information relevant to the individual (e.g., name, contact information, etc.). A partition 62 is a logical grouping of leaf nodes 68. Leaf nodes 68 are assigned to partitions 62, and partitions 62 are assigned to users 64 to describe which leaf node(s) 68 a particular individual may query. The IAP 12 may include various privileges. A structure may be used for the privileges that includes an identity field. The identity field contains a bit field that represents the commands a particular identity may execute within the IAP 12. This identity field can change depending on the entitlements granted to a user. An example of a list of privileges and associated descriptions is included in Table 1 below.

TABLE 1
Example Privileges for IAP Roles

| Privilege | Bit | Description |
|---|---|---|
| READ_LEAF_THREATS | 0 | Read threat events from a leaf node. |
| AUTHENTICATE | 32 | Commands related to identity |
| | | validation and identity group signing. |
| GENERIC_SESSION | 33 | Generic session related commands used |
| | | by a client to understand what the |
| | | session is capable of (e.g., fetch |
| | | current privilege set) |
| ECHO | 64 | Generate management echo messages. |

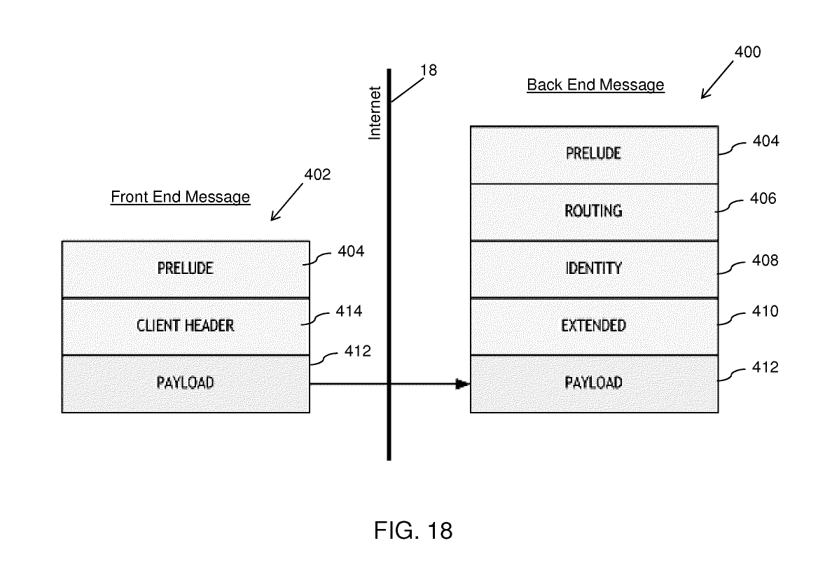

Turning now to FIG. 18, an internal message 400 format has been defined for the IAP 12 that describes how a message 400 flowing between components in the IAP 12 should be structured. All messages 400 sent across the IAP 12, regardless of the source or destination component of the system, are formatted the same way, unless the messages 400 are being sent to or from the web services, the format for external messages 402 being discussed in greater detail below. The message 400 used internally by the IAP 12 includes a message prelude 404, a routing header 406, an identity header 408, an extended header 410, and a payload 412. For external messages 402, only the prelude 404 and payload 412 are the same as the internal messages 400, with the routing header 406, identity header 408, and extended header 410 stripped out and replaced with a client header 414, which is specific to the client corresponding with the IAP 12.

The message prelude 404, located at the beginning of a message 400, is used to describe the overall structure of the message 400. The prelude 404 is binary data of fixed length that can be quickly interpreted to determine the format and location of the other sections of the message 400. Prelude numeric header values may be stored in network byte order. In one example, the prelude 404 includes the following fields shown in Table 2.

TABLE 2
Example Prelude Structure

| | Size | |
|---|---|---|
| Field | (bytes) | Description |
| Version | 4 | The version field is an integer representing the |
| | | overall format of the message. Where design |
| | | changes occur to the prelude header format, this |
| | | value will be incremented so the receiving node |
| | | can correctly interpret the message. |
| Length | 4 | Total length of message, including prelude |
| | | header. |
| Route offset | 4 | Number of bytes offset of the routing header, |
| | | from the beginning of the message. |
| Identity | 4 | Number of bytes offset of the identity header, |
| offset | | from the beginning of the message. |
| Extended | 4 | If an extended header exists in the message, |
| offset | | the number of bytes offset of the extended |
| | | header from the beginning of the message. If |
| | | 0, no extended header is present on the |
| | | message. |
| Payload | 4 | Number of bytes offset of the payload, from |
| offset | | the beginning of the message. |

The routing header 406 includes information that describes the route a message 400 should take within the IAP messaging system. The routing header 406 includes binary information of fixed length, with numeric values stored in network byte order. Table 3 below illustrates an example structure for the routing header.

TABLE 3
Example Routing Header Structure

| | Size | |
|---|---|---|
| Field | (bytes) | Description |
| Version | 4 | An integer representing the version of the routing |
| | | header. Where the routing header is changed, this |
| | | value can be incremented so the receiving |
| | | component can correctly interpret the message. |
| | | The routing header version is distinct from the |
| | | overall message version allowing the routing |
| | | header to be modified independently of other |
| | | sections of a message. |
| Source realm | 16 | The source realm is a 16 byte NULL terminated |
| | | string representing the realm a message was |
| | | generated from. |
| | | This value is populated by the sending component |
| | | prior to submitting the message to the hub. |
| Source ID | 16 | The source ID is a 16 byte NULL terminated |
| | | string representing the ID (component name) |
| | | of the component that generated the message. |
| | | The source realm and source ID combined will |
| | | make up the source address of the message. |
| Destination | 16 | The destination realm of the message. This |
| realm | | value is populated by the sending component |
| | | prior to submitting the message to the hub. |
| Destination | 16 | The destination ID of the message. This |
| ID | | value is populated by the sending |
| | | component prior to submitting the |
| | | message to the hub. |
| | | This value, along with the destination realm |
| | | forms the destination address of a message. |
| | | The hub, granted any message access control |
| | | checks succeed, will route messages to |
| | | components based on this address. |
| TTL | 4 | The TTL value is set initially by the sending |
| | | component, and decremented each time a message |
| | | is forwarded within the topology. |
| | | This value can be used to detect and prevent |
| | | routing loops as the messaging topology |
| | | increases in complexity. |
| | | Initially this value will be set to 1, to |
| | | reflect the central broker model in use |
| | | for messaging. Therefore, when components |
| | | receive a message from the hub, this value |
| | | should be 0. |

The identity header 408 includes information related to the identity of the entity (e.g., user) that generated a message 400. Note that this is not the identity of the component that generated the message 400. The identity header 400 in this example includes binary information of fixed length, stored in network byte order. However, it can be appreciated that the identity header 408 may also be implemented using a variable size in order to allow a list of leaf nodes 40 the user can access to be expanded. Table 4 below illustrates an example of a structure for an identity header 408.

TABLE 4
Example Identity Header Structure

| | Size | |
|---|---|---|
| Field | (bytes) | Description |
| Version | 4 | An integer representing the version of the |
| | | identity header. This value is used in a |
| | | similar manner as described in the |
| | | description for the routing header version. |
| Session | 16 | 128 bit session ID value. If a particular |
| | | message is not associated with an active |
| | | session being managed by the session |
| | | handler, this value will be filled with 0. |
| Authentication | 1 | 8 bit authentication server ID (server that |
| ID | | authenticated session) |
| Initialization | 4 | 32 bit initialization time of session. |
| Time | | |
| Privilege Mask | 16 | 128 bit privilege mask. This value is a |
| | | bit field representing which privileges |
| | | this particular session has access to. |
| Realm | 16 | If a session is associated with a particular |
| | | user, this value will be a NULL terminated |
| | | string representing the realm a user belongs |
| | | to. |
| | | Otherwise, this field will be filled with 0. |
| Partitions | 4 | 32 bit partition bit field, corresponding to |
| | | partition access applied to a particular user |
| | | within the user's realm. |
| Leaf Nodes | Variable | List of leaf nodes session has access to |
| ID | 16 | If a session is associated with a particular |
| | | user, this value will be a NULL terminated |
| | | string representing the name of the user. |
| | | Otherwise, this field will be filled with 0. |
| Signature | 4 | Length of signature stored in signature field. |
| Length | | |
| Signature | 48 | DSA (EI-Gamal) signature that can be |
| | | utilized to cryptographically validate |
| | | the authenticity and integrity of fields |
| | | in the identity header. |
| | | The manner this field is populated by, |
| | | and how it can be validated is defined |
| | | in other sections of this document. |

The extended header 410 is intended to allow future expansion for special message types in a convenient manner.

The payload 412 of the message 400 encapsulates the actual message information being exchanged between components within the IAP 12. Table 5 below illustrates an example structure for the payload 412 of the message 400.

TABLE 5
Example Payload Structure

| | Size | |
|---|---|---|
| Field | (bytes) | Description |
| Version | 4 | An integer representing the version of |
| | | the payload component of the message. |
| Category | 4 | An integer describing the message category. |
| | | A category represents a set of commands. For |
| | | example, authentication and chat can be |
| | | considered categories of messages. |
| Type | 4 | An integer describing the message type. See |
| | | the message types section for additional |
| | | information. |
| Command | 4 | An integer describing the command to be |
| | | executed by the receiving node. In the |
| | | case of a response to a command, the |
| | | command will be set to the same value as |
| | | existed in the request. |
| Request ID | 4 | A request ID value populated by the |
| | | component generating the message. |
| | | This value can be used by the |
| | | requesting component to map a |
| | | response to an initial request. |
| | | This value must always be set. |
| ACK | 4 | A random ACK value, if the message is |
| | | classified as reliable. If this value |
| | | is set to something other then 0, the |
| | | receiving component must send a message |
| | | with type ACK with no payload when it |
| | | receives and processes the message. |
| Message ID | 16 | UUID that uniquely identifies this |
| | | particular message. Each message must |
| | | have a UUID. |
| Data | Variable | Command payload (see payload data |
| | | field section). |

Several generic message categories may also exist. Table 6 below describes various categories that may be utilized. For each category, a set of valid commands exist, the command itself being included within the serialized data field.

TABLE 6
Example Message Categories

| Category | Description |
|---|---|
| AUTH | Authentication related activities. This includes |
| | commands used for session establishment, and |
| | session validation. |
| USERREG | User registration commands. This includes |
| | commands related to IAP user management |
| | activities such as additions, deletions, |
| | and password changes. |
| MGMT | IAP core management related messages. This |
| | includes messages related to service |
| | profiling, monitoring, and heartbeats. |
| MGMTPRIV | IAP core management messages requiring |
| | enhanced privileges or access control |
| | checks. This includes but is not limited |
| | to topology access control changes, |
| | service start/stop, and debugging. |
| LEAFDATA | Commands related to access to leaf node |
| | data stores, changes to leaf node |
| | configuration, or other events involving |
| | security services implemented by leaf |
| | nodes. |
| SUMMARY | Commands related to access to summary services. |
| REPORT | Commands related to access to IAP ad-hoc |
| | reporting services. |
| ERROR | Error notifications. |
| STATE | The message is related to component state |
| | transition (e.g., a component has come |
| | online). These messages are never routed, |
| | and are interpreted only by the hub. |
| NOTIFICATION | The message is a notification (e.g., an |
| | alert). |
| AUDIT | Auditing information generated by |
| | components in the architecture |
| TICKET | Commands related to ticket management |

The following message types may be used in the IAP 12, provided in Table 7 below.

TABLE 7
Example Message types

| Type | Description |
|---|---|
| REQUEST | The message represents a request. |
| RESPONSE | The message is a response to an original request |
| | message. |
| INPROGRESS | The message is a notification that a job is executing. |
| ERROR | The message is an error notification. |
| NOTIFY | The message is a general notification that will have no |
| | corresponding response (e.g., a REQUEST that does |
| | not require a RESPONSE). |
| ACK | The message is an acknowledgement for a message |
| | classified as reliable. |

The data field included in the payload 412 of a message 400 is a data structure that can be interpreted by connected components. In some embodiments, this will be a protocol buffers serialized data structure. Components that receive a message 400 de-serialize the data stored in the payload 412, and can then subsequently access the information in the message 400 as required. In the other direction, when a component is generating a message 400, it can package the data in the payload 412 as required (e.g., using serialization of a protocol buffers object). In other embodiments, the data field may contain information structured in formats other then a protocol buffers serialized object. A receiving node in the system should understand how to interpret the data field based on the category and command associated with the message 400.

Various commands may be utilized within the IAP framework, and for each category, a set of valid commands exists. An illustrative, non-exhaustive list of commands, organized by category, is outlined below in Table 8.

TABLE 8
Example Commands and Command Categories

| Category | Command | Description |
|---|---|---|
| AUTH | SESSION_INIT | Given a set of user credentials, |
| | | establish a user session within the |
| | | IAP core. |
| | SESSION_CLOSE | Close an active session. |
| | AUTHENTICATE | Authenticate a credential set, |
| | | returning a signed identity group. |
| | SESSION_ENTITLEMENTS | Retrieve a list of privileges and leaf |
| | | node targets that a particular session |
| | | has access to. |
| | SESSION_VALID | Detect if a particular client session is |
| | | still valid. |
| USERREG | USER_PRIV_GET | Given an IAP realm and user, return |
| | | privilege entitlements. |
| | USER_PRIV_SET | Given an IAP realm and user, set |
| | | privilege entitlements. |
| | REALM_USERS_GET | Given a security realm, return |
| | | member users. |
| | USER_INFO | Return information (e.g., real name) |
| | | associated with a particular IAP user. |
| | USER_PASSWD | Given an IAP user, set authentication |
| | | information (e.g., password). |
| MGMT | ECHO | Ping a given component on the |
| | | topology. |
| | DESCRIBE | Request a component on the topology |
| | | describe itself. |
| MGMTPRIV | SILENCE | Request a component on the topology |
| | | stop sending messages to bus. |
| LEAFDATA | QUERY_THREAT | Execute a query on threat event |
| | | stores. |
| | FETCH_THREAT | Fetch threat event details. |
| SUMMARY | | |
| REPORT | | |
| ERROR | HUB_BAD_IDENTITY | A private identity sent by a component |
| | | is unknown to the hub. |
| | HUB_UNKNOWN_SOURCE | The source address specified in a |
| | | message is unknown to the hub. |
| | HUB_UNKNOWN_DEST | The destination address specified in a |
| | | message is unknown to the hub. |
| | HUB_SRC_MISMATCH | The source address specified in a |
| | | message does not match what the |
| | | hub expects. |
| | PARSE_FAIL | A component failed to properly parse |
| | | a message. |
| | HUB_FW_DROP | A message was dropped due to |
| | | message access control checks. |
| | HUB_DROP_INACTIVE_ROUTE | A message was sent to a destination |
| | | address that is valid, but the |
| | | destination component is not online. |
| | HUB_DROP_LOG_FAIL | The message was dropped because it |
| | | could not be properly audited. |
| | ACCESS_DENIED | Privilege checks failed. |
| | BAD_IDENTITY_SIGNATURE | The signature associated with an |
| | | identity header could not be validated. |
| | NO_PARTITION_ACCESS | Access to data in the requested realm |
| | | partition is not permitted. |
| | INVALID_CLIENT_SESSION | A supplied client session ID is not |
| | | (any longer) valid. |
| STATE | ONLINE | Component notifies hub it is online |
| | | and ready to receive messages. |
| | OFFLINE | Component notifies hub it is about to |
| | | transition offline and to stop |
| | | forwarding messages/generating |
| | | heart beats. |
| NOTIFICATION | THREAT_ALERT | An alert notification related to threat |
| | | monitoring generated by a leaf node. |

An error category exists that is used to describe error conditions that have occurred within the IAP core. The type associated with an error message should be set to ERROR. Where an error condition occurs as the result of a message 400 (e.g., a QUERY_THREAT request), components can reply with an error message setting the request ID in the error message to the request ID of the original request. The command is then set appropriately to the type of error. Some error messages can be configured to pass additional details as payload data.

For each component connected to the hub 40, the hub 40 maintains a status for the component, marking it as either online or offline. Components marked as offline are not monitored, and do not receive messages 400. When a component connects, it will send a STATE ONLINE command notifying the hub 40 it is ready to receive commands 400. Inversely, when a component is exiting, it will send a STATE OFFLINE message 400 to notify the hub 40 it is transitioning to an offline state, and to stop sending messages 40 and heart beat events to that component. Where a component does not respond to heart beat messages generated by the hub 40 in a given period of time, the component will be automatically marked as offline by the hub 40. The component then generates a STATE ONLINE message 400 again to begin receiving events.

If a message 400 has a value set in the payload ACK field, the message 400 is considered reliable. When a component receives a message 400 of this type, it replies to receipt of the message 400 to acknowledge it has received and processed the message. IAP components can queue messages 400 to disk that are reliable messages prior to submitting them to the topology. The components may then periodically replay these messages 400 (e.g., if no ACK has been received within a given time frame). Once an ACK is received, the components can then remove the message 400 from the disk queue. The receiving component replies to a reliable message 400 with an ACK message type, with the ACK and request ID payload fields set to the values in the original message 400.

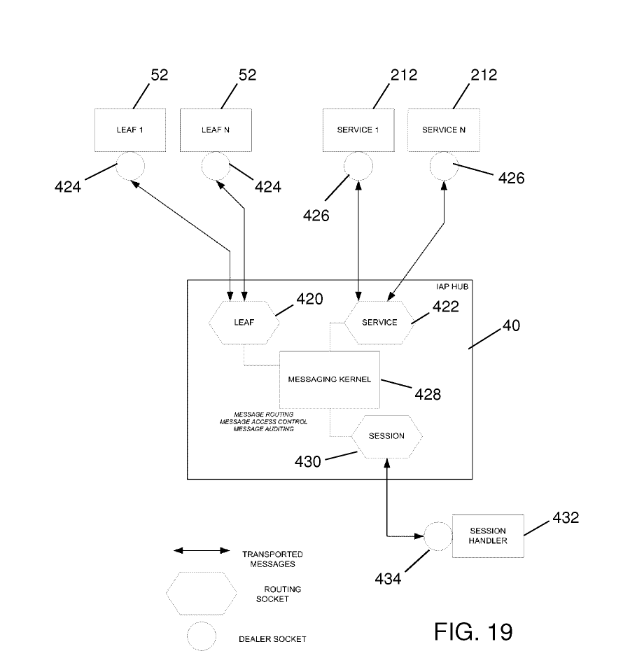

An example of a messaging topology utilized by the IAP 12 is shown in FIG. 19, and includes a series of components that can understand and read/write IAP messages 400. The components are connected via a message broker based on a socket framework, e.g. an existing library with functions that can be utilized. FIG. 19 illustrates a messaging topology used by the IAP 12.

In FIG. 19, a hub 40 is shown, which includes a messaging kernel 428 configured to communicate via a leaf socket 420, a service socket 422, and a session socket 430. The leaf socket 420 communicates with the leaf nodes 52 via respective leaf dealer sockets 424, and the service socket 422 communicates with the services 212 via respective service dealer sockets 426. Similarly, the session socket 430 communicates with a session handler 432 via a session dealer socket 434. The messaging kernel 428 is responsible for receiving messages 400 from the routing sockets 420, 422, 430, identifying where the message 400 should be forwarded, performing any necessary access control checks, and sending the message 400 out to the correct routing socket 420, 422, 430. Messages 400 may be received using one socket 420, 422, 430 and sent out on another socket 420, 422, 430. In other examples, the messages 400 may be received and sent on the same routing socket (e.g., in the case of a first service 212 sending a message 400 to a second service 212).

When an IAP component connects to the hub 40, it submits a private identity value. The private identity value is known only to the hub 40 and the connecting component, and can be considered a shared secret. The hub 40 should be aware of the private identity of a given component prior to the component becoming part of the topology. Therefore, a registration process should be executed on the hub 40 to register a component's private identity. The private identity is utilized internally within the messaging topology in determining which entity, connected to a routing socket 420, 422, 430, should receive a message 400. Such a registration process may involve a configuration on the hub 40, where a component's private identity is mapped to a public routing address. This public routing address corresponds to the source/destination realm/ID field of the routing header 406 in a message 400.

When the messaging kernel 428 receives a message, it inspects the destination ID field of the routing header 406. The messaging kernel 428 references an internal configuration to see if the destination ID field exists and, if so, what private identity is associated with that destination ID. If the message 400 should be forwarded, the messaging kernel 428 sends the message 400 using the desired socket 420, 422, 432, and uses the private identifier as the address when forwarding the message 400, so that the message 400 reaches the correct component. The messaging kernel 428 may also be configured to support a special address, where the realm and destination ID fields are filled with zero (0). This address is intended to represent the hub 40, and components can use this address if they wish to send a message 400 to the hub 40.

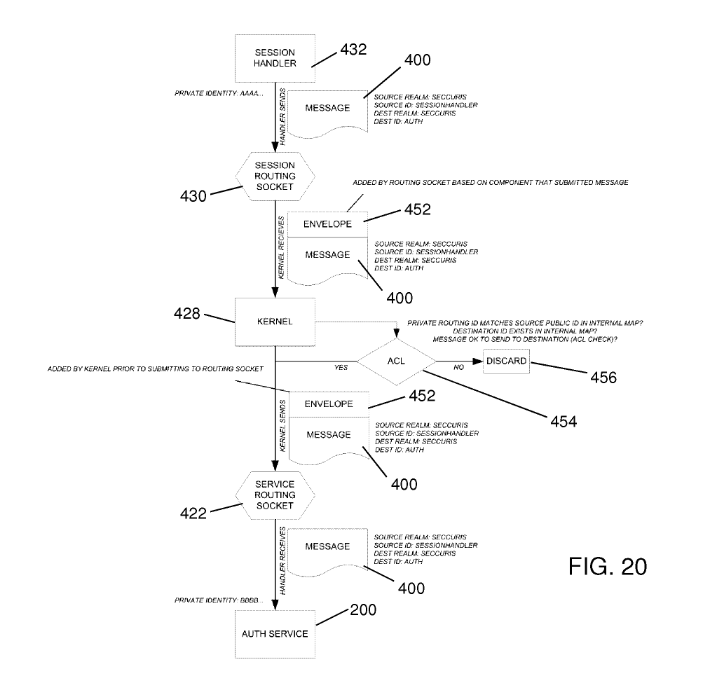

The following example describes how the routing mechanism of the topology of FIG. 19 can be executed, using the scenario of a session handler 432 wanting to send a message 400 to the authentication services 200. The example is illustrated with reference to FIG. 20.

In this example, the hub 40 would be configured with the private identity values, and corresponding public routing ID's of the session handler 432 and authentication services 200. This configuration would also include the socket identifier that component will connect to. The messaging kernel 428 would have the following configuration stored internally (shown in Table 9 below), among other entries for other components also connected to the hub 40:

TABLE 9
Example Identity Values

| Public ID (Realm/Name) | Private ID (socket identity) | Socket |
|---|---|---|
| SECCURIS/SessionHandler | AAAAAAAAAAAAAAAAAAAAAAAAAAAAAAAA | SESSION |
| SECCURIS/Auth | BBBBBBBBBBBBBBBBBBBBBBBBBBBBBBBB | SERVICE |

When the session handler 432 component connects to the session routing socket 430 on the hub 40, it submits the private identity (AAAAAAAAAAAAAAAAAAAAAAAAAAAAAAAA) set in the component's configuration. This also occurs for the authentication node.

At this stage, the components are registered on the bus, and may begin exchanging messages 400 with other components. As described earlier, a component connected to the bus only knows it's private ID value and is not aware of the private ID values of other connected components. As such, the messaging kernel 428 converts public ID values to private ID's to facilitate routing and maintain the compartmentalization of the topology.

As illustrated in FIG. 20, when the session handler 432 sends a message 400 that is received by the hub 40, the session routing socket 430 provides the message 400 to the hub 40 with an attached identity envelope 452. The identity envelope 452 contains the private identity of the component that generated the message 400. The topology uses these envelopes 452 to allow the receiving application the ability to differentiate between the component that generated a message 400 when there are multiple endpoints connected to the same routing socket 420, 422, 430. When the messaging kernel 428 receives the message 400, it validates the source ID and realm (SECCURIS/SessionHandler) of the routing header 406 in the message 400, and matches the private ID (AAAAAAAAAAAAAAAAAAAAAAAAAAAAAAAA) in the envelope 400 to protect against component public source ID masquerading.

Next, the messaging kernel 428 extracts the destination ID and realm (SECCURIS/Auth) from the message 400. The messaging kernel 428 then consults its internal public ID/private ID map to determine what private identifier the message 400 should be routed to. If it cannot locate a matching destination ID and realm in the map table, the message 400 is not forwarded. When the messaging kernel 428 locates the correct private ID value (in this case BBBBBBBBBBBBBBBBBBBBBBBBBBBBBBBB), it performs any required access control checks. If the access control checks pass, the message 400 is forwarded to the destination component. In the example shown in FIG. 20, the messaging kernel 428 routes the message to the service routing socket 422 which removes the envelope 452 and the message 400 is routed to the ultimate destination, namely the authentication services 200.

The messaging kernel 428 may also be configured to support the concept of route groups, where a route group is a group of components that can be addressed with a single address. For example, multiple authentication services 200 components may exist. The hub 40 maintains a route groups configuration, that can include an entry mapping SECCURIS/Auth to the multiple authentication services components. If a component requests delivery of a message to SECCURIS/Auth, the hub 40 will determine which component in the group gets the message 400 (e.g., round-robin). When the destination component that receives the message 400 replies to it, it will set the source address fields to its address such that the receiving component knows which component actually responded to the message 400 from the route group.

Each component that connects to the messaging system can be configured with a private identity. The hub 40 should also know the component's private identity, and have a map between the component's private identity and the public routing ID, as described above. Maintaining the confidentiality of the private routing ID, such that outside a given component, the hub 40 is the only other device that knows the ID, ensures that the private IDs are unlikely to be compromised. If a component private ID is compromised, a malicious attacker in a position to connect to the bus would be able to submit the ID of the compromised component to begin receiving messages 400 for that component.

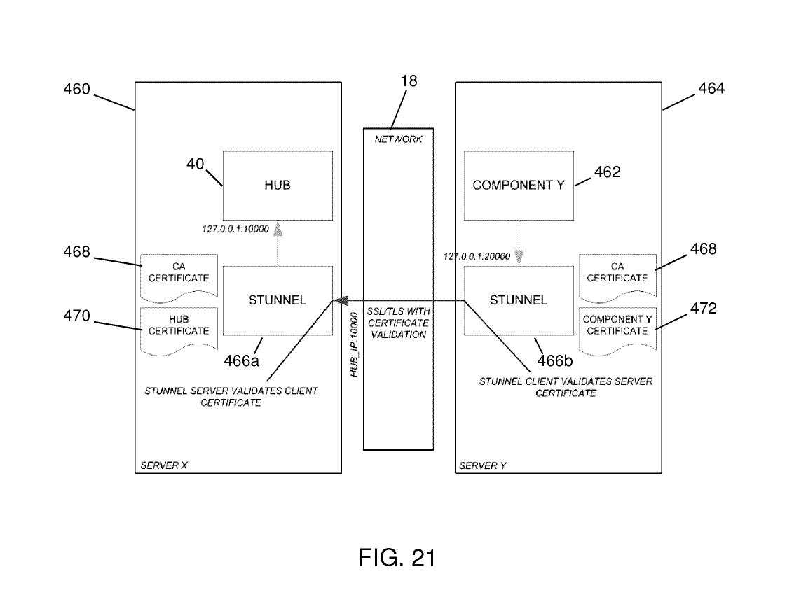

Transport encryption and endpoint authentication may be implemented as shown in FIG. 21. In the example shown in FIG. 21, SSL/TLS is utilized between components 460, 462, 464 exchanging messages 400 with the hub 40 in order to protect the confidentiality and integrity of information in transit between the devices 460, 464. This can be accomplished through the use of an stunnel SSL wrapper 466a, 466b, applied to proxy TCP connections between endpoints 460, 462, 464 and the IAP hub 40. In the configuration shown in FIG. 21, upon establishing a connection with the hub 40, the hub 40 and component Y 462 will exchange certificates 470, 472. The certificates 468 should be correctly signed for the connection to be permitted. The components 460, 464 should also have certification authority (CA) certificates 468.

From the perspective of the hub 40 and component Y 462, they are communicating with each other directly. However the stunnel modules 466a, 466b encapsulate the communications within an SSL tunnel to be sent over the network, e.g., the internet 18.

In many examples, components do not need the ability to send and receive all types of messages 400. For example, reporting services will only need to send and receive reporting related commands and do not need to have the ability to send authentication commands. The hub 40 may be configured to have a message access control capability, which may be thought of as a messaging firewall. A firewall policy exists on the hub 40, and messages 400 that flow into the hub 40 are passed through a policy check. If the source component should be permitted to send a particular type of message 400 to the destination component, the message 400 is passed; otherwise the message 400 is blocked and a HUB_FW_DROP error message is generated and sent to source component. Messages 400 can be filtered using the following criteria:

Source realm/ID

Destination realm/ID

Message Type (e.g., RESPONSE, REQUEST, etc)

Message Category (e.g., MGMT, AUTH)

Events

Classification Taxonomy

Leaf Agent

Command Modules

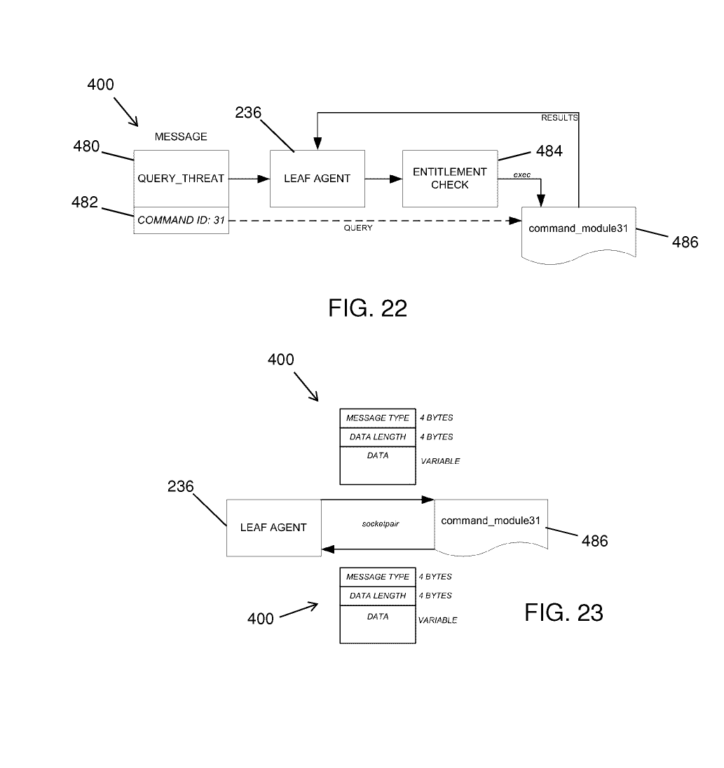

In the context of the leaf node 52, a request coming in from the IAP 12 should correspond in most cases to the execution of a module stored on the leaf node 52. The payload command will contain a particular command identifier, which corresponds to a module located on the file system that is run by the leaf node 52. The leaf node 52 then executes the query asynchronously, passes the results back to the leaf agent 236, which is required to package the result set up into a response message 400 and push the message 400 into the messaging system. FIG. 22 illustrates application of an entitlement check 484 by a leaf agent 236 after receiving a message 400 including a query threat 480 and having a particular command ID 482. The entitlement check 484 is performed using a command module 486 and the results are fed back to the leaf agent 236.

The leaf agent 236 receives a message 400 of type QUERY_THREAT, translating to execution of command ID 31 with a set of parameters. The leaf agent 236 is responsible for validating the privilege set associated with the identity. If it validates, a command module 486 located on the file system is executed.

The arguments passed in the query message 400 will be passed to the command module 486 through a socket pair connecting the command module 486 and the leaf agent 236, as shown in FIG. 23. This socket pair will be persistent, and exist for the lifetime of execution of the command module 486. The payload data stored in a protocol buffers object will be passed to the command module 486 through the pipe, and the response will be submitted back to the agent through the same pipe.

As illustrated in FIG. 23, a small amount of metadata is passed prior to the actual data so the command module 486 understands primarily how much information to read. The message type will be the type of message as described in the message types section. When the command module 486 completes its execution, the results are packaged according to the command type, and the results are sent back to the requestor. Certain commands may generate progress messages (INPROGRESS) as they execute for interpretation by the leaf node 52. The model shown in FIG. 23 is beneficial as it decouples leaf agent query functionality from the leaf agent 236 itself. Functionality can be added or removed from a particular leaf agent 236 without having to modify any leaf agent code.

The above describes a scenario where the leaf agent 236 receives a request, and spawns a command to fulfill the request. There are also scenarios where the leaf agent 236 will execute a command when it starts up, and this command will persist while the leaf agent 236 runs. The persistent commands will be specified in a configuration file, which will include the following:

Description of persistent command (e.g., Notifier1)

Command to execute (e.g., notifier.py)

Class of persistent command (e.g., NOTIFICATION)

NOTIFY messages are the only messages 400 supported between the leaf agent 236 and a persistent command. The message class is used to inform the leaf agent 236 what the role of the persistent command is. When data is received from a persistent command, based on the class an appropriate payload header will be constructed, and the message 400 will be forwarded to the correct address (e.g., the leaf agent 236 will be aware data received from a persistent command of type NOTIFICATION will be forwarded to SECCURIS/Notification).

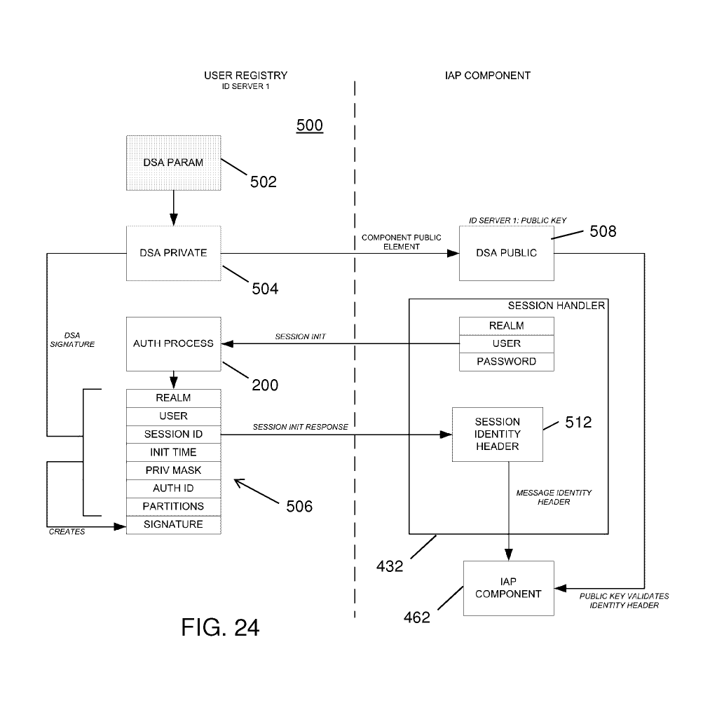

Turning now to FIG. 24, when a user registry component 500 authenticates a session, a cryptographic token is associated with the session. This token can be used to validate that the properties of a session, such as the privilege set or session user ID, have not been manipulated at any point after the initial authentication of the user occurs. Each user registry component 500 in the IAP is assigned a DSA pubic/private key pair. The private key 504 is generated from a DSA parameter 502 (e.g., 2048 bit), has a corresponding public key 508, and is located on the authentication services 200 the key is associated with. After a user registry component 500 validates various attributes 506 supplied by a session handler 432 are authentic, including, for example, the username, realm, and password material, the user registry component 500 responds with session information to a session identity header 512 stored in the session handler 432, which includes a signed cryptographic signature for the session.

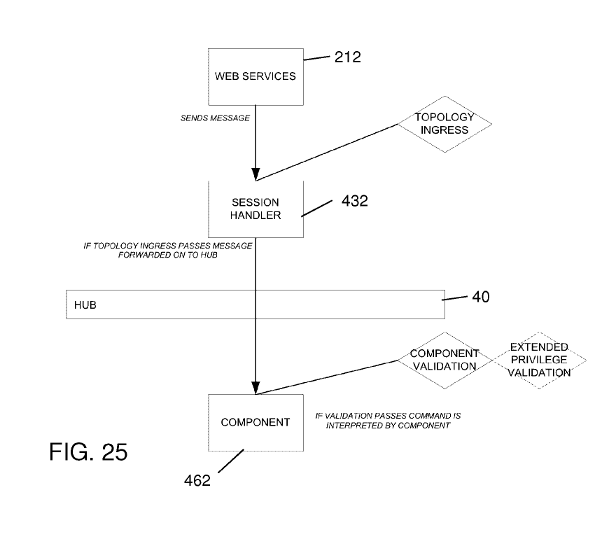

The identity header 512 associated with a valid session in the IAP component 462 has a set of privileges associated with it. These privileges, along with the user's realm can be used to validate if a particular request should be permitted. Privilege checks in the backend occur in two phases. Each phase, and the manner in which the privilege checks are conducted are described as follows, referring to FIG. 25.

Topology ingress checks are performed by the session handler component 432. When a client device such as the web service 212 sends the session handler 432 a message 400, the session handler 432 performs the following validation checks prior to submitting the message to the bus, shown in Table 10:

TABLE 10
Example Validation Checks

| | Applicable | |
|---|---|---|
| Phase | Fields | Description of Check |
| 1 | Payload | Sanity checks of payload fields occur. The |
| | | session handler validates fields are set |
| | | appropriately, and the message is marked as a |
| | | request. |
| 2 | Privilege Mask | The privilege mask associated with the session is |
| | Payload | checked against the command in the payload. If |
| | Command | the privilege required for the command is not |
| | | present in the privilege mask, an |
| | | ACCESS_DENIED error response message is |
| | | generated and sent to the client. |

If the command will result in a message being sent to a
leaf node, the following checks are also conducted.

| | | |
|---|---|---|
| 3 | Identity Realm | Validate realm present in identity matches realm |
| | Destination | associated with destination leaf node in request |
| | Leaf Realm | (e.g., the target field in a FETCH_THREAT |
| | | event). If not, and ACCESS_DENIED error |
| | | response message is generated. |
| | | Note: Additional checks occur at the leaf node, |
| | | related to the partitions the user has access to. |
| | | See the component validation section. |

Component validation checks are performed by the component 462 receiving the message 400. This could be a client leaf node agent 236, or other service components (e.g., reporting) interpreting a message 400 sent by the session handler 432 (e.g., a message 400 associated with a user session). Identity related component validation checks would not apply to messages being sent between components in the IAP core. Example phases are shown below in Table 11:

TABLE 11
Example Phases

| | Applicable | |
|---|---|---|
| Phase | Fields | Description of Check |
| 1 | Authentication | Validate a public key exists on the component for |
| | ID | the authentication server ID. If no key exists, a |
| | | BAD_IDENTITY_SIGNATURE error response |
| | | is generated. |
| 2 | Identity Header | Using the authentication server's public key, |
| | Signature | validate the signature for the identity header. If |
| | | the signature validation fails, a |
| | | BAD_IDENTITY_SIGNATURE error response |
| | | is generated. |
| 3 | Payload | Sanity checks of payload fields occur. The |
| | | component validates fields are set appropriately. |
| 4 | Identity | The privilege mask associated with the session is |
| | Privilege Mask | checked against the command in the payload. If |
| | Payload | the privilege required for the command is not |
| | Command | present in the privilege mask, an |
| | | ACCESS_DENIED error response message is |
| | | generated. |

Components 462 may execute the basic validation checks described above. However, certain commands will have additional access control checks that are to be executed by the receiving component 462 prior to fulfilling the request. These are herein referred to as Leaf Store Query Extended Validation, and applicable Commands are shown below in Table 12:

TABLE 12
Example Extended Validation Command

| Component Type | Category | Command |
|---|---|---|
| Leaf | LEAFDATA | All |

The following additional checks (shown in Table 13) may be executed on a component 462 interpreting the commands listed in the applicable commands table. These checks would occur after standard component validation checks.

TABLE 13
Example Additional Checks

| Phase | Applicable Fields | Description of Check |
|---|---|---|
| 1 | Identity Realm | Validate realm present in identity matches |
| | Component Realm | realm associated with this leaf. If not, an |
| | | ACCESS_DENIED error response is |
| | | generated. |
| 2 | Partition | Validate the partition present in the identity |
| | Component Partition | header grants access to this particular leaf |
| | | node within the realm (the components |
| | | assigned partition). If not, a |
| | | NO_PARTITION_ACCESS error response |
| | | is generated. |

The session handler 432 component is responsible for implementing the interface the web service 212 talks to in order to communicate with the IAP core services 34. It can be considered a bridge, interpreting the messages 400 sent from the web services 212, adding necessary features to the message 400 (such as a routing header 406) and submitting them to IAP services or leaf nodes 52 on the backend.

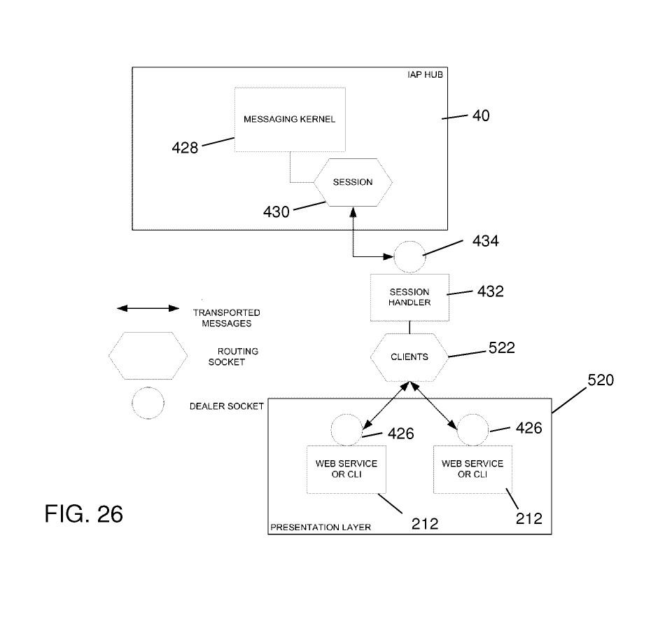

FIG. 26 illustrates an example configuration for enabling the session handler 432 to be integrated with the hub 40 and web services 212. As shown in FIG. 26, the session handler 432 utilizes a session dealer socket 434 and a clients routing socket 522, in order to communicate with the hub 40 and a presentation layer 520 for the web services 212. The session dealer socket 434 is similar to other dealer sockets used by backend components such as the leaf agent 52 to communicate with the hub 40. The session handler 432 also utilizes the clients routing socket 522, on which it receives connections from web services 212. The clients routing socket 522 may also be considered, in this architecture, as a “client interface”. The clients routing socket 522 is utilized to enable the session handler 432 to know which web service 212 generated a particular message 400, allowing the session handler 432 to route a response back to the correct web service 212.

As discussed above, client, web or external messages 402 (see also FIG. 18), which are sent and received on the client interface, are slightly different than those sent and received by components connected directly to the hub 40, i.e. different than the internal messages 400. The hub 40 has several header components (e.g., the routing and identity headers 406, 408) that are used internally for hub routing and backend session and privilege management. These headers are not required for use by clients connecting to the external session manager 206, as connected clients such as a web service 212 are precluded, in this messaging system, from addressing IAP backend components directly.

Clients communicating on the client interface with the session manager 206 use the same payload 412 in a message 400 (as shown in FIG. 18), but supply a simplified client header 414 encapsulating the information needed. The components of the external client message 402 prelude header 404 are described in Table 14 below.

TABLE 14
Example Prelude Header for External Message

| | Size | |
|---|---|---|
| Field | (bytes) | Description |
| Version | 4 | The version field is an integer representing the overall |
| | | format of the message. Where design changes occur to |
| | | the prelude header format, this value will be |
| | | incremented so the receiving node can correctly |
| | | interpret the message. |
| Length | 4 | Total length of message, including prelude header. |
| Client | 4 | Number of bytes offset of the client header, from the |
| offset | | beginning of the message. |
| Payload | 4 | Number of bytes offset of the payload, from the |
| offset | | beginning of the message. |

An example of a client header 414 for an external message 414 is shown below in Table 15.

TABLE 15
Example Client Header

| | Size | |
|---|---|---|
| Field | (bytes) | Description |
| Version | 4 | An integer representing the version of the client |
| | | header. |
| CSID | 16 | 128 bit client session ID. This is used to map a request |
| | | to a particular IAP hub session. If the request is not |
| | | applicable to an existing session this value will be |
| | | filled with 0. |

The payload component 412 of the external message 402 should be the same as that of the internal message 400, regardless of whether it is on a client interface, or being sent between hub components. See the description of the payload header in the hub messaging section for additional details.

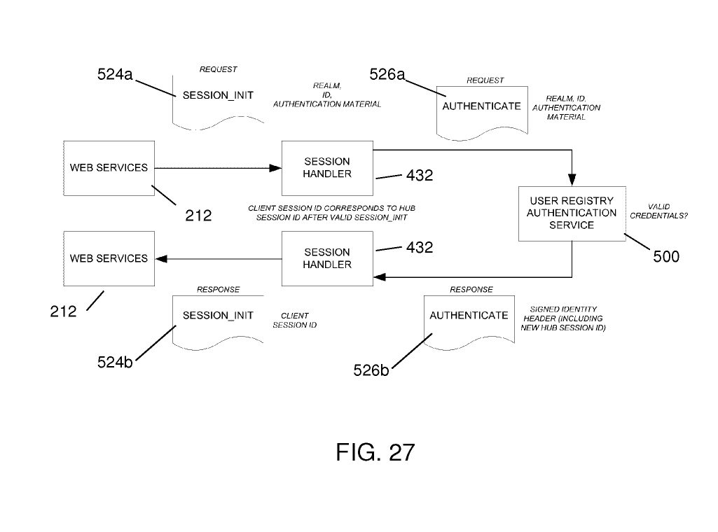

Clients access IAP services by first establishing a session. Once a session has been established, commands can be executed in the context of the existing session. Web services 212 may generate a SESSION_INIT request 524a that will result in a session being established if the parameters of the request 524a are correct (e.g., credentials valid). FIG. 27 illustrates an example of a message flow demonstrating how web services 212 can initialize an IAP hub session. The session handler 232 receives the request 524a and sends an AUTHENTICATE request 526a to the user registry service 500 to determine if the supplied credentials are valid. If so, the user registry returns an AUTHENTICATE response 526b to the session handler 432, which issues a SESSION_INIT response 524b to the web services 212, which includes a client session ID. The client session ID passed to the web services 212 can then be used to reference the identity header 408 stored by the session handler 432 for the duration of the client session. The web services 212 component only receives the client session ID value, and should not be exposed to the identity details that have been signed by the user registry authentication service 500. It can be appreciated that in this way, future calls for the session into the session handler 432 will result in the session handler 432 adding the identity header 408 to the message 400 before submitting it to the correct service on the IAP 12.

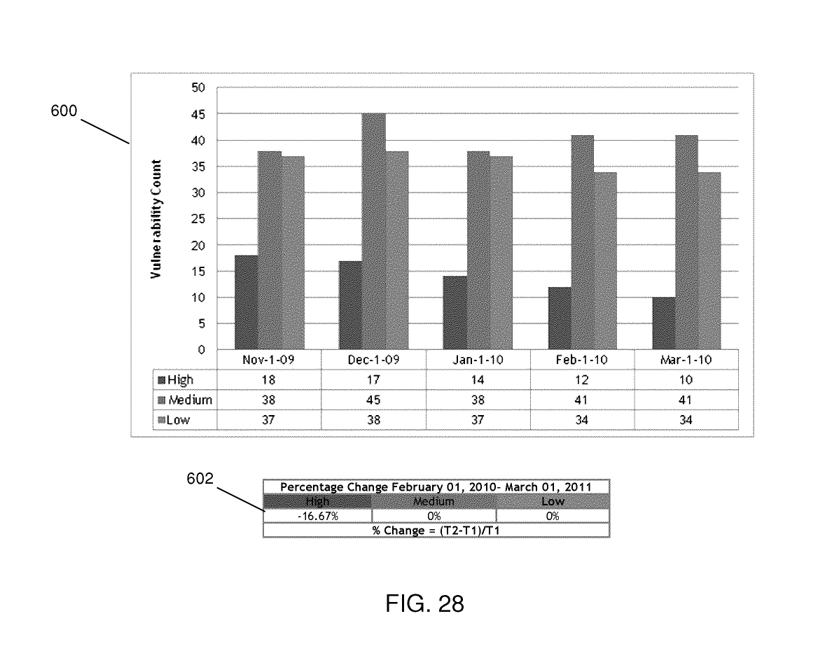

FIGS. 28 to 30 illustrate example vulnerability reports that may be generated after monitoring a client environment 10 for a period of time. In FIG. 28, a number of unique or distinct vulnerabilities discovered through vulnerability scanning or assessment activities for a set of assessed assets or policies is shown in a vulnerability chart 600. High, medium, and low vulnerabilities are classified through vulnerability scoring system metrics. In addition to visualizing the number of high, medium and low threats during each time period (as shown in chart 600), percentage changes during particular time periods may also be computed and reported as shown in chart 602.

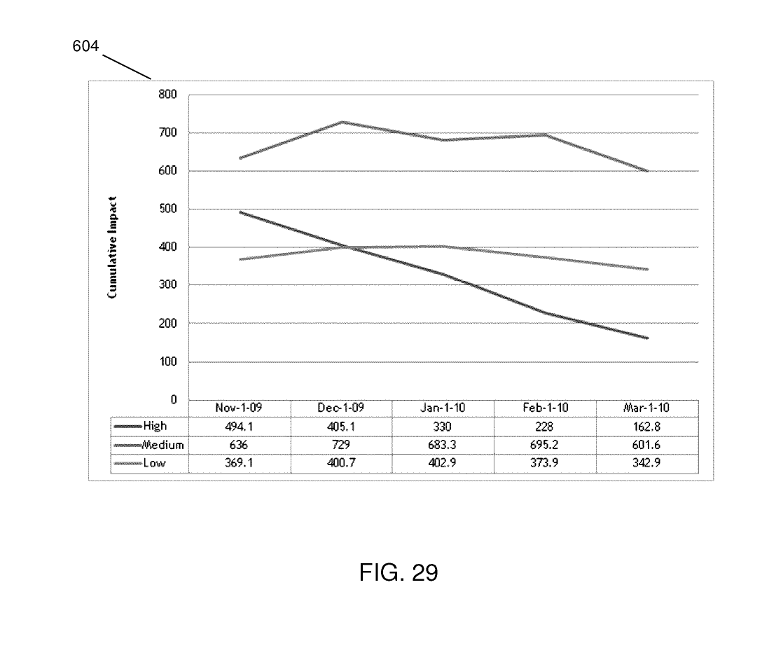

FIG. 29 illustrates an example chart 604 containing an overall cumulative impact for the assessed environment 10. The cumulative impact associated with an asset takes into account the asset classification information (confidentiality, integrity, and sensitivity) as provided to the entity providing the IAP services, by the client. These values are then calculated against scores assigned to the vulnerabilities (numerical representations of the inherent characteristics of a vulnerability) found on the system resulting in the cumulative impact. The chart 604 in FIG. 29 displays the overall cumulative impact over the previous five (5) scans. The overall cumulative impact is broken out into high-, medium-, and low vulnerabilities showing their individual impacts. High vulnerabilities have a greater weighting and as such few high vulnerabilities can result in a higher cumulative impact than many low vulnerabilities.

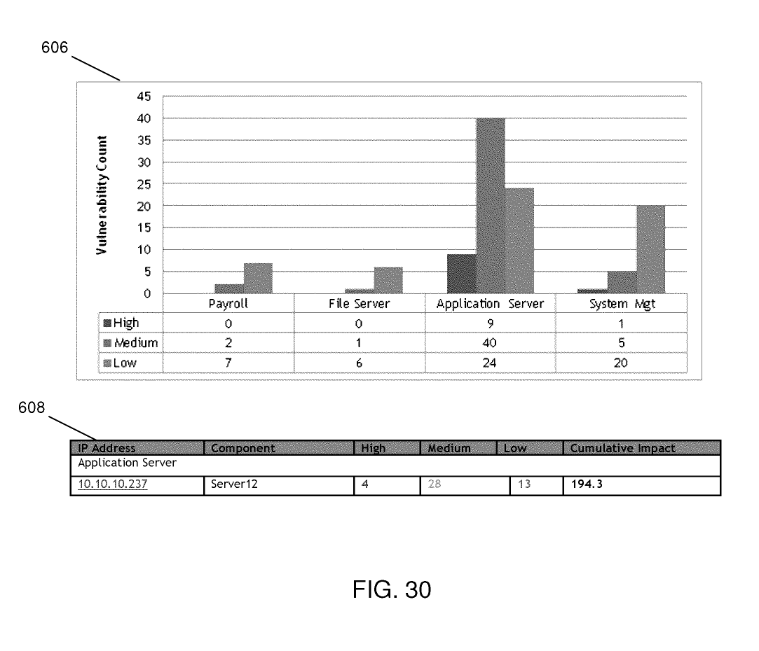

FIG. 30 illustrates an example of chart 606 detailing a number of unique or distinct vulnerabilities discovered for particular asset subgroups as defined by the client. The following chart represents discovered vulnerabilities for a current scanning period. The table 608 shown in FIG. 32 lists the components for the above asset subgroups detailing the number of high-, medium-, and low-impact vulnerabilities ordered by cumulative impact.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the leaf node 52, collector appliance 54, hub 40, ticketing component 42, etc.; or any component of or related thereto or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method of messaging comprising:
at an information security system, comprising a computer system distinct from an external source;
receiving a first message from the external source, the first message comprising a header component included by the external source and a payload;
generating a second message from the first message by modifying the first message to add at least one additional header component for routing the second message internally within a messaging framework; and
routing the second message to at least one component in the messaging framework using the routing header.

2. The method of claim 1, wherein the at least one additional header component comprises a routing header to identify a routing path within the messaging framework.

3. The method of claim 1, wherein the at least one additional header component comprises an identity header having information related to the identity of an entity that generated the first message.

4. The method of claim 1, wherein for incoming data, the first message is modified to create the second message by modifying the header component included by the external source with the at least one additional header component, and wherein for outgoing data, the second message is modified by removing the at least one additional header component to hide routing information from a public environment.

5. The method of claim 1, wherein corresponding first and second messages are of any one of the following types: request messages, response messages to request messages, progress messages providing a notification that a job is executing, error messages providing an error notification, notify messages not requiring a response, and acknowledgement messages.

6. The method of claim 1, wherein the first message is used for sending the payload over a public network from the external source to the messaging framework, and the second message is used within a secure environment provided by the messaging framework.

7. The method of claim 1, wherein the messaging framework is provided by an information assurance portal configured for monitoring data in a client environment external to the information assurance portal and comprising the external source.

8. The method of claim 7, wherein the client environment comprises a plurality of external sources monitored by a client service, the client service being configured to generate the first message and send the first message to the information assurance portal for conversion to the second message and routing within the information assurance portal for monitoring information obtained from the payload.

9. A method of monitoring event data comprising:
at an information security system, comprising a computer system distinct from a data source;
receiving event data from the data source;
generating an event object from the event data;
analyzing the event object using at least one correlator to determine a threat to an entity associated with the data source;
generating a notification when the at least one correlator detects the threat; and sending the notification to a monitoring service to generate a ticket for resolving the threat.

10. The method of claim 9, further comprising generating a report providing details of the threat.

11. The method of claim 9, wherein the event object comprises a binary format.

12. The method of claim 9, further comprising adding information to the event object for use by the at least one correlator.

13. The method of claim 9, further comprising applying at least one filter to determine if the threat can be ignored.

14. The method of claim 9, further comprising generating a key for the event object to enable events to be grouped together.

15. The method of claim 14, wherein events having a same key are sent to a same correlation instance.

16. The method of claim 9, further comprising storing the event object with other event objects and enabling the stored event objects to be queried using a plurality of predefined functions.

17. A method of monitoring data in a client environment, the method comprising:
obtaining data from the client environment indicative of activity within the client environment at a first hardware component within the client environment; and
the first component sending the data to a second hardware component over a secure connection with the second component, the second hardware component being located remote from the first hardware component in a monitoring backend infrastructure.

18. The method of claim 17, wherein the second hardware component is located an intermediary separate from a central monitoring service, the method further comprising the second hardware component processing the data to generate a notification and sending the notification to a third hardware component for initiating a remediation of a threat associated with the notification.

19. The method of claim 17, wherein the second hardware component is located at a central monitoring service, the method further comprising the second component processing the data to generate a notification and sending the notification to a third hardware component for initiating a remediation of a threat associated with the notification.

20. The method of claim 17, wherein the client environment comprises a plurality of external sources monitored by a client service, the client service being configured to generate a first message and send the first message to the second hardware component for conversion to a second message and routing within an information assurance portal for monitoring information obtained from the data.

21. A non-transitory computer readable storage medium, storing one or more programs for execution by one or more hardware processors of a computer system distinct from an external source, the one or more programs including instructions for:
receiving a first message from the external source, the first message comprising a header component included by the external source and a payload;
generating a second message from the first message by modifying the first message to add at least one additional header component for routing the second message internally within a messaging framework; and
routing the second message to at least one component in the messaging framework using the routing header.

22. (canceled)
